(19) United States
(12) Patent Application Publication
(10) Pub. No.: US 2010/0156967 A1
(43) Pub. Date: Jun. 24, 2010

(54) LIQUID CRYSTAL DISPLAY ELEMENT, METHOD OF DRIVING THE ELEMENT, AND ELECTRONIC PAPER UTILIZING THE ELEMENT

(75) Inventors: Tsuneo Watanuki, Kawasaki (JP); Makoto Fukuda, Kawasaki (JP); Fumio Yamagishi, Ebina (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/717,578

(22) Filed: Mar. 4, 2010

Related U.S. Application Data
(63) Continuation of application No. PCT/JP2007/068255, filed on Sep. 20, 2007.

(51) Int. Cl. G09G 3/36; G09G 5/10

(52) U.S. Cl. 345/691; 345/89

(57) ABSTRACT

A method of driving a liquid crystal display element having a cholesteric liquid crystal is provided. The driving method includes a first step for driving a liquid crystal for a relatively short voltage application period after resetting the liquid crystal at pixels to a planar state to display preliminary gray levels and a second step for driving the liquid crystal for a voltage application period longer than the above voltage application period to display desired gray levels.

This application is a continuation of International Application No. PCT/JP2007/068255, filed Sep. 20, 2007.

### BACKGROUND OF THE INVENTION

1. Field of the Invention

The present invention relates to a liquid crystal display element in which a liquid crystal composition forming a cholesteric phase is driven for displaying images, a method of driving the element, and electronic paper utilizing the element.

2. Description of the Related Art

Recently, various enterprises and universities are actively engaged in the development of electronic paper. One type of display elements used in electronic paper is reflection-type display elements utilizing liquid crystal compositions which form a cholesteric phase (hereinafter referred to as cholesteric liquid crystals). Cholesteric liquid crystals have excellent features such as a memory display function which allows an image to be semi-permanently displayed in an unpowered state, vivid color display characteristics, high contrast characteristics, and high resolution characteristics.

Taking advantage of above-described features, reflection-type display elements utilizing cholesteric liquid crystals are advantageously used as electronic paper in the field of portable apparatus such as electronic books which are the most promising application, other applications including sub-displays of mobile terminal apparatus and display sections of IC cards.

Reflection-type display elements utilizing cholesteric liquid crystals can be used in out-door advertising boards. Taking advantage of the memory display function, a large image such as an advertisement can be displayed outdoor for a long time without consuming electric power, and the image can be rewritten into another image when a certain period of time passes.

Patent Document 1: JP-A-2002-014325

Patent Document 2: JP-A-2004-004200

Patent Document 3: JP-A-2004-219715

As described above, reflection-type display elements utilizing cholesteric liquid crystals have the memory display function which allows information to be semi-permanently held once it is written even if no electric power is supplied. However, the elements have a problem in that they are subjected to the “image sticking phenomenon”. Specifically, when a still image is kept displayed for a long time, a faint afterimage of the displayed image remains even after a rewrite is performed to display another image.

Although it is assumed that image sticking is attributable to factors such as affinity between moisture, ionic impurities or a liquid crystal and substrate interfaces, the cause of the phenomenon has not been sufficiently identified yet. Under the circumstance, various approaches toward improved resistance to image sticking have been proposed. For example, Patent Document 1 discloses a refreshing process to mitigate image sticking, the approach including the step of applying a voltage to a cholesteric liquid crystal whenever a predetermined time interval passes such that the liquid crystal will align substantially parallel to the direction in which the voltage is applied. Patent Document 2 discloses an approach including the step of converting image data using an NOT element when the image has been displayed for a predetermined period and writing an image based on the converted data. Patent Document 3 discloses an approach including the step of detecting conditions (such as a temperature) under which image sticking is likely to occur and updating a screen of a liquid crystal display panel to display an image sticking preventing image (which may be, for example, a monotonous black image covering the entire screen). Since the level of image sticking varies in a complicated manner depending on the history of rewrites performed on a displayed image of interest, the period for which the image is displayed, and the temperature at the time of display, it is difficult to prevent the image sticking phenomenon completely. Further, when an image sticking preventing image for suppressing image sticking is unexpectedly displayed, another problem may arise in that a viewer may be made uncomfortable or annoyed by such an image.

### SUMMARY OF THE INVENTION

It is an object of the invention to provide a liquid crystal display element which is less vulnerable to an afterimage attributable to the image sticking phenomenon, a method of driving the element, and electronic paper utilizing the element.

The above-described objects are achieved by a method of driving a liquid crystal display element, including the steps of (a) driving a liquid crystal for a relatively short voltage application period to display preliminary gray levels, and (b) driving the liquid crystal for a voltage application period longer than the relatively short voltage application period to display desired gray levels.

The above invention is characterized in that it including a reset step for resetting the liquid crystal to an initial state prior to the preceding step (a).

The above invention is characterized in that the voltage applied to the liquid crystal at the step (a) is higher than the voltage applied to the liquid crystal at the step (b).

The above invention is characterized in that the preliminary gray levels displayed at the step (a) include only relatively high and/or low gray levels.

The above invention is characterized in that the preliminary gray levels are binary values.

The above-described objects are achieved by a method of driving a liquid crystal display element displaying an image with N gray levels (N represents 3 or a greater natural number), the method including the steps of dividing a gray level “i” into M sub gray levels to display the gray level i (0≦i≦N−1) by performing a superimposing rewrite process M times (M≧2), and performing the M rewrite processes with conditions for voltage application to the liquid crystal varied between the first to M-th processes such that the M sub gray levels are sequentially superimposed to display the gray level “i”.

The above invention is characterized in that the sum of the M sub gray levels is given by (i1+i2+ . . . +i(m−1)+im)=i when the M sub gray levels of the gray level “i” are represented by “i1”, “i2”, . . . “i(m−1)”, and “im”.

The above invention is characterized in that sa<s(a+1) and/or t(a+1)<ta holds true, where sa represents a maximum gray level within a gray level range expressed by 0≦i<(N−1)/2 and ta represents a minimum gray level within a gray level range expressed by (N−1)/2≦i≦(N−1), the gray level ranges being defined for a gray level obtained as a result of the first to a-th (1≦a≦M) superimposing rewrite processes, and s(a+1) represents a maximum gray level within a gray level range expressed by 0≦i<(N−1)/2 and t(a+1) represents a minimum gray level within a gray level range expressed by (N−1)/2≦i≦(N−1), the gray level ranges being defined for a gray level obtained as a result of the (a+1)-th rewrite process performed after the a-th process.

The above invention is characterized in that the voltage applying conditions include voltages applied to the liquid crystal at the first to M-th rewrite processes having magnitudes descending in the order of the processes and periods for voltage application to the liquid crystal at the first to M-th rewrite processes having durations ascending in the order of the processes.

The above invention is characterized in that when the (a+1)-th rewrite process is performed to superimpose a sub gray level i(a+1) on a pixel having a gray level (i1+i2+ . . . +i(a−1)+ia) obtained at the a-th process, the voltage application period of the voltage applying conditions used at the (a+1)-th rewrite process is a difference between a voltage application period t to obtain the gray level (i1+i2+ . . . +i(a−1)+ia+i(a+1)) and a voltage application period t to obtain the gray level (i1+i2+ . . . +i(a−1)+ia).

The above invention is characterized in that the liquid crystal is reset to an initial state prior to the first rewrite process.

The above invention is characterized in that the liquid crystal is a cholesteric liquid crystal.

The above invention is characterized in that the initial state of the liquid crystal is a planar state in which light having a particular wavelength is selectively reflected.

The above-described objects are achieved by a liquid crystal display element including a liquid crystal display panel having a first substrate formed with a plurality of scan electrodes extending in a first direction, a second substrate formed with a plurality of data electrodes extending in a second direction different from the first direction, and a liquid crystal layer formed between the first and second substrates, a scan electrode driving circuit applying a scan pulse voltage that is a combination of different voltage levels to the plurality of scan electrodes, the voltage levels depending on whether the electrodes are selected or not, a data electrode driving circuit applying a data pulse voltage that is a combination of different voltage levels to the plurality of data electrodes in association with the scan pulse voltage, the voltage levels depending on data to be written, and a control section supplying pulse control signals for controlling the voltage levels of the scan pulse voltage and the data pulse voltage to the scan electrode driving circuit and the data electrode driving circuit, wherein the control section displays gray levels by performing the steps of (a) driving the liquid crystal for a relatively short voltage application period to display preliminary gray levels, and (b) driving the liquid crystal for a voltage application period longer than the relatively short voltage application period to display desired gray levels.

The above invention is characterized in that the control section resets the liquid crystal to an initial state prior to the step (a).

The above invention is characterized in that the voltage applied to the liquid crystal at the step (a) is higher than the voltage applied to the liquid crystal at the step (b).

The above invention is characterized in that a selection period for the scan electrodes at the step (a) is shorter than a selection period for the scan electrodes at the step (b).

The above invention is characterized in that the liquid crystal is a cholesteric liquid crystal.

The above invention is characterized in that the initial state of the liquid crystal is a planar state in which light having a particular wavelength is selectively reflected.

The above invention is characterized in that a plurality of the liquid crystal display panels are stacked, and the initial states of the liquid crystals in the liquid crystal display panels are planar states in which respective light rays having different wavelengths are selectively reflected.

The above-described objects are achieved by electronic paper displaying an image, including the liquid crystal display element according to the above invention.

The invention makes it possible to display a high quality image by suppressing the occurrence of an afterimage attributable to the image sticking phenomenon.

### BRIEF DESCRIPTION OF THE DRAWINGS

FIG. 1 is a graph for explaining operating principles of a liquid crystal display element in a mode for carrying out the invention, the graph showing relationships between reflectances of a particular ray of visible light and amounts of image sticking observed at two arbitrary pixels of a display screen of the liquid crystal display element;

FIG. 2 is a graph for explaining the operating principles of the liquid crystal display element in the mode for carrying out the invention, the graph showing relationships between reflectances of the liquid crystal and voltage application periods;

FIG. 3 is a graph for explaining the operating principles of the liquid crystal display element in the mode for carrying out the invention, the graph showing relationships between periods for voltage application to the liquid crystal and amounts of image sticking.

FIG. 4 is a view showing a schematic configuration of the liquid crystal display element in the mode for carrying out the invention taken from the front side of a display screen;

FIG. 5 is a schematic view of a sectional configuration of the liquid crystal display element in the mode for carrying out the invention taken along the imaginary line A-A in FIG. 4;

FIG. 6 is a table showing conditions for voltage application to the liquid crystal of the liquid crystal display element in the mode for carrying out the invention to cause changes from the planar state to intermediate states;

FIG. 7 is a timing chart (chart 1) for voltage application used in a method of driving the liquid crystal display element in the mode for carrying out the invention;

FIG. 8 is a timing chart (chart 2) for voltage application used in the method of driving the liquid crystal display element in the mode for carrying out the invention;

FIG. 9 is a timing chart (chart 3) for voltage application used in the method of driving the liquid crystal display element in the mode for carrying out the invention;

FIG. 10 is a timing chart (chart 4) for voltage application used in the method of driving the liquid crystal display element in the mode for carrying out the invention;

FIGS. 11A and 11B are illustrations showing gray level patterns used in the method of driving the liquid crystal display element in the mode for carrying out the invention;

FIGS. 12A to 12C are illustrations for explaining the method of driving the liquid crystal display element in the mode for carrying out the invention (instance 1);

FIGS. 13A to 13C are illustrations for explaining the method of driving the liquid crystal display element in the mode for carrying out the invention (instance 2);

FIGS. 14A to 14C are illustrations for explaining the method of driving the liquid crystal display element in the mode for carrying out the invention (instance 3);

FIGS. 15A to 15C are illustrations for explaining the method of driving the liquid crystal display element in the mode for carrying out the invention (instance 4);

FIGS. 16A to 16E are illustrations for explaining the method of driving the liquid crystal display element in the mode for carrying out the invention (instance 5);

FIGS. 17A to 17E are illustrations for explaining the method of driving the liquid crystal display element in the mode for carrying out the invention (instance 6);

FIGS. 18A to 18D are illustrations showing Embodiment 1 in which an image is displayed using the liquid crystal display element in the mode for carrying out the invention;

FIGS. 19A to 19D are illustrations showing Embodiment 2 in which an image is displayed using the liquid crystal display element in the mode for carrying out the invention;

FIGS. 20A to 20E are illustrations showing binary display images suitable for an additional rewrite performed when an image is displayed using the liquid crystal display element in the mode for carrying out the invention;

FIG. 21 is a diagram showing a configuration of a control section 23 of the liquid crystal display element in the mode for carrying out the invention in detail; and

FIGS. 22A to 22C are illustrations showing specific examples of electronic paper EP having the liquid crystal display element in the mode for carrying out the invention.

### DETAILED DESCRIPTION OF THE INVENTION

### Principles of Driving

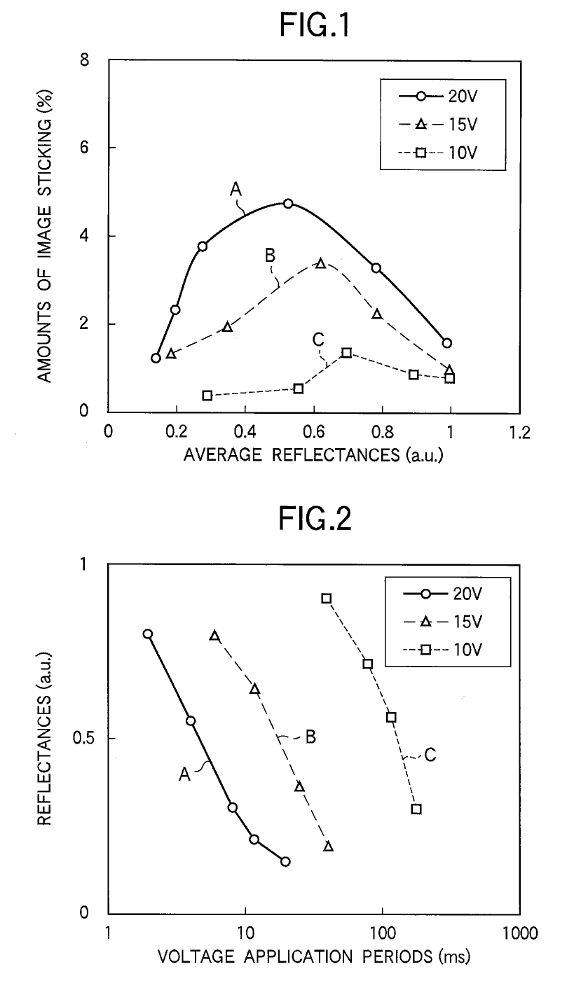

First, principles of driving of a liquid crystal display element in a mode of carrying out the invention will be described with reference to FIGS. 1 to 3. The liquid crystal display element in the present mode of the invention utilizes a cholesteric liquid crystal. By varying the state of an electric field generated in the liquid crystal, the liquid crystal can be put in a planar state in which a certain type of visible light is selectively reflected or a focal conic state in which the visible light is transmitted.

A cholesteric liquid crystal is a liquid crystal mixture obtained by adding a relatively great amount of chiral additive (also referred to as “chiral material”) to a nematic liquid crystal to a chiral material content of several tens percent by weight (e.g., a content ranging from 10 to 40 percent by weight). The chiral material content is a value discussed based on an assumption that the nematic liquid crystal component and the chiral material total at 100 percent by weight. When a nematic liquid crystal includes a relatively great amount of chiral material, a cholesteric phase that is a strong helical twist of nematic liquid crystal molecules can be formed in the liquid crystal. A cholesteric liquid crystal is also referred to as “chiral nematic liquid crystal”. A cholesteric liquid crystal has bi-stability (memory characteristics). Once a cholesteric liquid crystal is put in the planar state, the focal conic state, or an intermediate state that is a mixture of the planar and focal conic states by applying an electric field to the same, the state is maintained with stability even if the electric field is thereafter removed.

Although the cause or mechanism of the image sticking phenomenon has not been fully identified, close studies carried out by the inventors have revealed that a cholesteric liquid crystal exhibits different response characteristics after it is kept in the planar state for a certain period of time and after it is kept in the focal conic state.

An image on a display screen of a liquid crystal display element is formed by a combination of pixels reflecting particular rays of light and pixels transmitting light. The liquid crystal is in the planar state at pixels in a light-reflecting region and in the focal conic state at pixels in a transmitting region. Therefore, when a still image is kept displayed for a long time using the memory display function, the liquid crystal exhibits response characteristics which are different between the pixels in the reflecting and transmitting regions.

Therefore, when it is attempted to display the same gray level at a pixel in the reflecting region and a pixel in the transmitting region in this state, there will be a display density difference between the pixels attributable to a difference in liquid crystal response characteristics between the pixels. For this reason, when a still image displayed in the memory display mode is written into a different image, the resultant image will have density differences of various degrees because the liquid crystal exhibits different response characteristics at each pixel of the display screen. It is supposed that such density differences are the cause of image sticking and hence an afterimage.

Further, the inventors found that density differences between pixels results in a more significant afterimage, the higher the pulse-like voltage applied to the liquid crystal (driving voltage) and the shorter the application time of the voltage. The inventors also found that there are greater density differences between pixels when intermediate gray levels are displayed.

FIG. 1 shows relationships between reflectances of a particular ray of visible light and amounts of image sticking observed at two arbitrary pixels of a display screen of a liquid crystal display element. Amounts of image sticking (%) are shown along the vertical axis, and average reflectances (in arbitrary units) of the two pixels are shown along the horizontal axis.

The liquid crystal was kept in the planar state at one of the pixels and in the focal conic state at the other pixel for seven days, and the image was thereafter rewritten into a different image by applying a voltage to the pixels under the same voltage applying condition (driving condition) to render the same gray level. An amount of image sticking (%) is defined as the ratio of a difference ΔY between reflectances observed at the two pixels after the rewrite into the different image to a maximum reflectance at the pixels (a reflectance in the planar state). The amount of image sticking corresponds to a density difference between the pixels.

The rewrite into the different image was carried out by applying a reset voltage of about 36 V to the liquid crystal at all pixels of the display screen of the liquid crystal display element to reset the liquid crystal to the planar state and driving the liquid crystal by applied voltages Vp thereafter. Three types of applied voltages Vp, i.e., voltages of 10 V, 15 V, and 20 V were used. In FIG. 1, the curve A in the solid line, the curve B in the broken line formed by longer line segments, and the curve C in the broken line formed by shorter line segments represent relationships between amounts of image sticking (%) and average reflectances observed at the applied voltages Vp of 20 V, 15 V, and 10 V, respectively.

As will be understood from FIG. 1, when observed at the same average reflectance, a greater amount of image sticking occurs, the higher the voltage Vp applied to rewrite the image into a different image. That is, the amount of image sticking can be kept smaller by applying a lower voltage Vp for the rewrite into a different image.

Any of the curves A, B, and C is a convex curve having a peak near the center of the axis representing average reflectances. Amounts of image sticking represented near both ends of each curve are smaller than amounts of image sticking represented near the center of the curve. That is, when the image is rewritten into a different image, amounts of image sticking at pixels of high reflectances (high gray levels) and pixels of low reflectances (low gray levels) can be kept smaller than amounts of image sticking at pixels displayed at intermediate gray levels. Such a tendency is more significant, the higher the applied voltage Vp. That is, the tendency is especially significant on the curve A.

Although it depends on the displayed pattern of interest, an afterimage is less noticeable, the smaller the amount of image sticking. Specifically, when the amount of image sticking on an image can be kept at 3% or less, substantially no afterimage will be observed by common viewers of the image.

FIG. 2 shows after the liquid crystal at the pixels is reset to the planar state relationships between application periods of the same applied voltages Vp as shown in FIG. 1 and reflectances of the liquid crystal observed after the application of the voltages Vp. Reflectances of the liquid crystal (in arbitrary units) are shown along the vertical axis, and periods (ms) of voltage application to the liquid crystal are shown along the horizontal axis.

Referring to FIG. 2, the reflectance represented by any of the curves A, B, and C in FIG. 2 monotonously decreases as the application time increases. That is, when the applied voltage Vp is fixed, an arbitrary intermediate gray level can be displayed by varying the voltage application period. Since a cholesteric liquid crystal exhibits memory characteristics also in an intermediate state, an intermediate gray level can be similarly displayed by applying a short pulse voltage to the liquid crystal plural times at certain intervals.

As will be apparent from FIG. 2, when the same reflectance is to be obtained, the voltage application period becomes shorter, the higher the applied voltage Vp. In other words, the voltage application period becomes longer, the lower the applied voltage Vp. In order to obtain the same predetermined reflectance, the voltage application period must be varied depending on the value of voltage Vp applied to the cholesteric liquid crystal.

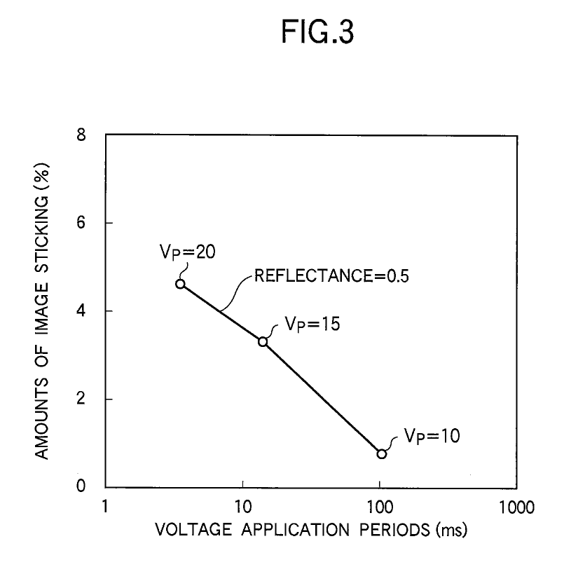

FIG. 3 shows a relationship between periods of voltage application to the liquid crystal and amounts of image sticking observed at a reflectance of 0.5 in the example shown in FIGS. 1 and 2. Amounts of image sticking (%) are shown along the vertical axis, and periods (ms) of voltage application to the liquid crystal are shown along the horizontal axis.

The curve in FIG. 3 represents changes in the amount of image sticking associated with different voltage application periods at which a reflectance of 0.5 is achieved. The amount of image sticking monotonously decreases as the voltage application period increases. The measurement was carried out at three points, i.e., applied voltage values Vp of 20 V, 15 V, and 10V which are listed in the ascending order of the respective voltage application periods required to obtain the voltage values.

As shown in FIG. 3, where the same reflectance is to be achieved, a greater amount of image sticking occurs when a relatively high voltage Vp is applied to shorten the voltage application period, and the amount of image sticking can be kept smaller when a relatively low voltage Vp is applied to increase the voltage application period. Such a tendency is similarly observed not only near the reflectance of 0.5 but also throughout the entire range of reflectances. Therefore, one possible approach toward a smaller amount of image sticking is a mode of driving in which the applied voltage Vp is kept relatively low to increase the voltage application period. However, such an approach results in a problem in that it will take a long time to rewrite an image.

As thus described, when it is attempted to rewrite an image in a short time, a great amount of image sticking occurs, and an afterimage will be noticeable. On the contrary, when it is attempted to suppress the amount of image sticking, it will take a long time to rewrite an image. That is, there is a trade-off between a reduction in an image rewriting period and suppression of the amount of image sticking.

Under the circumstance, a process of rewriting an image into another in the present mode of the invention includes at least two separate steps. Specifically, what is proposed is a driving method including a first step at which a liquid crystal at pixels is driven for relatively short voltage application periods after resetting the liquid crystal at the pixels to the planar state to display preliminary gray levels at the pixels and a second step at which the liquid crystal is driven for voltage application periods longer than the above-mentioned voltage application periods to display desired gray levels.

At the first step, a preliminary image can be displayed in a short time to allow a viewer to view at least a part of information (e.g., character information) although the information is incomplete. Then, the second step allows a complete image to be obtained by driving the liquid crystal for relatively long voltage application periods to display desired gray levels.

The voltage applied to the liquid crystal at the first step must be higher than the voltage applied to the liquid crystal at the second step. In other words, the voltages applied to the liquid crystal at the second step must be lower than the voltages applied to the liquid crystal at the first step.

Referring to the preliminary gray levels displayed at the first step, only gray levels near a higher end and/or a lower end of the gray level range are displayed. In other words, intermediate gray levels are not included in the preliminary gray levels displayed at the first step. Gray levels near the higher end and/or the lower end of the gray level range can be displayed with the amount of image sticking suppressed even when the liquid crystal is driven at relatively high applied voltage for relatively short voltage application periods. For this reason, only gray levels near the higher end and/or lower end of the gray level range are displayed as preliminary gray levels at the first step. As a result, a preliminary image allowing a viewer to view a part of information can be displayed in a short time with the amount of image sticking suppressed, although the information is incomplete.

The voltages applied to the liquid crystal at the second step and application periods of the voltages may be arbitrarily selected as long as the amount of image sticking can be sufficiently suppressed.

At the second step, the liquid crystal may be driven at a plurality of separate rewrite processes, and an applied voltage and a voltage application period may be set for each of the processes. In this case, a rewrite process employs a lower applied voltage, the later the process is performed. That is, each rewrite process requires a rewriting period longer than that of the preceding process.

At the second step, all gray levels can be completely displayed with the amount of image sticking suppressed in the region of intermediate gray levels where great amounts of image sticking can occur under liquid crystal driving conditions at the first step.

As will be detailed later with reference to the drawings, in the case of the so-called line sequential driving wherein gray levels are written in pixels by sequentially selecting a plurality of scan electrodes one after another, a frame display rate employed at the second step is lower than a frame display rate employed at the first step. The frame display rate at the second step may be set extremely low such that changes in an image slowly proceeds at the second step, which makes it possible to keep additional writes performed on the image less noticeable to a viewer.

### MODE OF INVENTION

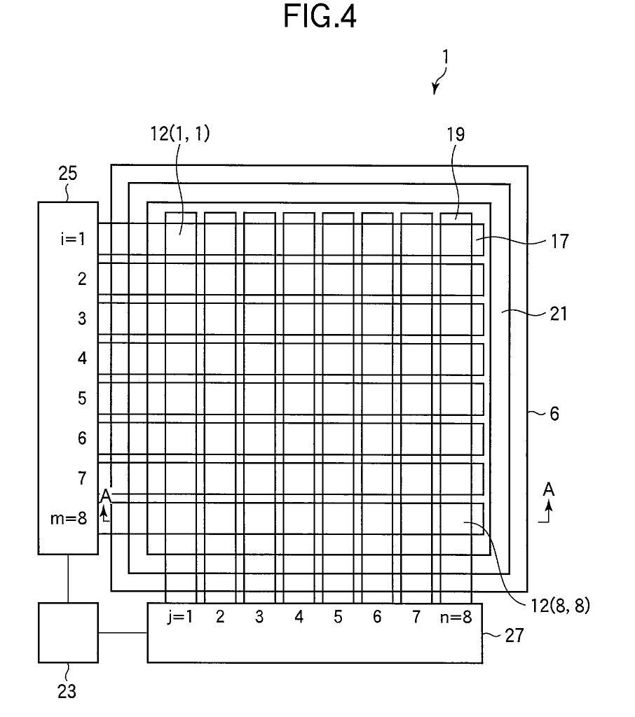

A basic configuration of a liquid crystal display element in the present mode of the invention will now be described in detail with reference to FIGS. 4 and 5. FIG. 4 is a view of a liquid crystal display element 1 in the present mode of the invention taken from the side of a display screen of the element to show a schematic configuration thereof. FIG. 5 is a schematic view of a sectional configuration of the liquid crystal display element 1 taken along the imaginary line A-A in FIG. 4. Referring to FIG. 5, the display screen is on the side of the element where a top substrate 7 is located, and external light (indicated by the arrow in a solid line) impinges on the display screen from above the substrate 7. An eye of a viewer and the viewing direction of the viewer (indicated by the arrow in a broken line) are schematically shown above the substrate 7.

As shown in FIG. 5, the liquid crystal display element 1 includes a pair of transparent substrates, i.e., a top substrate 7 and a bottom substrate 9 which are disposed opposite to each other with a predetermined cell gap d maintained between them. As shown in FIGS. 4 and 5, a seal material 21 is provided between the rectangular top substrate 7 and bottom substrate 9 in the form of a frame extending along the peripheries of the substrates. The top substrate 7 and the bottom substrate 9 are fixed opposite to each other by the seal material 21. For example, a cholesteric liquid crystal 3 for green (G) which selectively reflects green (G) light is enclosed between the top substrate 7 and the bottom substrate 9 by the seal material 21. A light absorbing layer 15 is disposed on a bottom surface of the bottom substrate 9. Obviously, the function of a light absorbing layer may alternatively be provided by coloring the bottom substrate 9 itself instead of providing the light absorbing layer 15.

Scan electrodes 17 are formed on an interface side of the top substrate 7 where the substrate is in contact with the liquid crystal 3, and data electrodes 19 are formed on an interface side of the bottom substrate 9 where the substrate is in contact with the liquid crystal 3. Both of the electrodes 17 and 19 are formed from a transparent electrode material. As shown in FIG. 4, the scan electrodes 17 extend in the form of stripes in the horizontal direction of the figure when the top substrate 7 and the bottom substrate 9 are viewed in the normal direction of the display screen. In the top-to-bottom direction of the figure, i rows (i=1 to m; and m=8 in this mode of the invention) of scan electrodes 17(i) are disposed in parallel. As shown in FIG. 4, the data electrodes 19 extend in the form of stripes in the vertical direction of the figure such that they face the scan electrodes 17 in an intersecting relationship with the liquid crystal 3 interposed between them. In the left-to-right direction of the figure, j columns (j=1 to n; and n=8 in this mode of the invention) of data electrodes 19(j) are disposed in parallel. Each of the intersections between the electrodes 17 and 19 constitutes a pixel 12. Thus, a display screen is formed by a plurality of pixels 12 (i,j) which are disposed in the form of a matrix having m rows and n columns. A liquid crystal display panel 6 is fabricated from the above-described components.

The liquid crystal 3 can be set in the planar state by applying a relatively high voltage between a top electrode 17 and a bottom electrode 19 for a predetermined period to set the liquid crystal 3 in the homeotropic state by a strong electric field thus generated in the liquid crystal 3 between the top electrode 17 and the bottom electrode 19 and thereafter weakening the electric field abruptly. In the planar state, liquid crystal molecules are sequentially rotated in the direction of the thickness of the gap between the top electrode 17 and the bottom electrode 19 disposed opposite to each other to form a helical structure. The helical structure has a helical axis which is substantially perpendicular to electrode surfaces of the top substrate 17 and the bottom substrate 19. In the planar state, light rays within a predetermined wave band in accordance with the helical pitch of the liquid crystal molecules are selectively reflected by the liquid crystal layer. The light rays reflected at this time are circularly polarized light rays which are left-handed or right-handed depending on the optical rotatory power (chirality) of the helical structure, and other types of light are transmitted by the liquid crystal layer. Natural light is a mixture of left-handed and right-handed circularly polarized light rays. It may therefore be considered that 50% of natural light which has entered the liquid crystal in the planar state is reflected and 50% of the light is transmitted. A wavelength λ resulting in the maximum reflection is given by λ=n·p where n represents the average refractive index of the liquid crystal and p represents the helical pitch of the same. Therefore, the average refractive index n and the helical pitch p of the liquid crystal 3 are determined such that, for example, the wavelength λ is in the range from 540 to 550 nm in order that green light is selectively reflected when the liquid crystal is in the planar state. The average refractive index n and the optical rotatory power can be adjusted by selecting the liquid crystal material and the chiral material appropriately. The helical pitch p can be adjusted by adjusting the chiral material content.

For example, the focal conic state can be obtained by applying a weak electric field having an intensity lower than that of the above-described strong electric field to the liquid crystal 3 for an application period longer than the above-mentioned predetermined period and thereafter weakening the electric field abruptly. In the focal conic state, liquid crystal molecules are sequentially rotated in an in-plane direction of the electrodes to form a helical structure, and the helical structure has a helical axis which is substantially parallel to the electrode surfaces. In the focal conic state, the liquid crystal 3 loses the selectivity of wavelengths to be reflected, and most of incident light rays are transmitted. Since the transmitted light rays are efficiently absorbed by the light absorbing layer 15 disposed on the bottom surface of the bottom substrate 9, a dark state (black) can be displayed. Thus, the liquid crystal display element 1 can display an image with a high contrast ratio.

For example, the intermediate state can be obtained by applying a predetermined electric field having an appropriately adjusted intensity to the liquid crystal 3 in the planar state for an application period which is also appropriately adjusted. That is, the liquid crystal 3 can be set in arbitrary intermediate states between the planar and the focal conic states by setting conditions for voltage application to the liquid crystal 3 in various ways. In an intermediate state, the ratio between reflected light and transmitted light is adjusted according to the ratio of presence between the planar and focal conic states, and the intensity of the reflected light changes accordingly. Thus, an intermediate gray level according to the intensity of the reflected light can be displayed.

### (Voltage Applying Conditions for Driving Liquid Crystal)

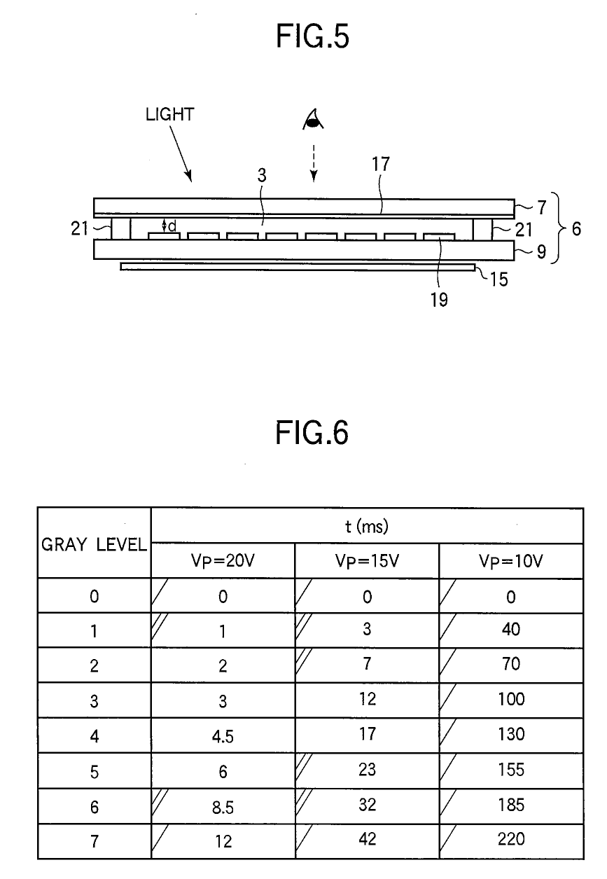

FIG. 6 shows examples of voltage applying conditions for application of voltages to the liquid crystal 3 to cause changes from the planar state to intermediate state. Referring to FIG. 6, an instance of display of eight gray levels, i.e., gray levels “0” to “7” will be described by way of example, the highest gray level “0” corresponding to the maximum reflectance obtained in the planar state, the lowest gray level “7” corresponding to the minimum reflectance obtained in the focal conic state. The column on the left side of FIG. 6 shows gray levels (gray level values). Specifically, the eight levels from the gray level “0” up to the gray level “7” are shown in the top-to-bottom direction of the column. Voltage application periods t (ms) associated with each value of the applied voltage Vp (V) are shown on the right side of FIG. 6. For example, when the voltage Vp applied to the liquid crystal 3 is 20 V, the voltage application period t is set at 0 ms to obtain the gray level “0”. Similarly, the voltage application period t is set at 1 ms to obtain the gray level “1”. The voltage application period t is set at 2 ms to obtain the gray level “2”. The voltage application period t is set at 3 ms to obtain the gray level “3”. The voltage application period t is set at 4.5 ms to obtain the gray level “4”. The voltage application period t is set at 6 ms to obtain the gray level “5”. The voltage application period t is set at 8.5 ms to obtain the gray level “6”. The voltage application period t is set at 12 ms to obtain the gray level “7”.

When the voltage Vp applied to the liquid crystal 3 is V, the voltage application period t is set at 0 ms to obtain the gray level “0”. The voltage application period t is set at 3 ms to obtain the gray level “1”. The voltage application period t is set at 7 ms to obtain the gray level “2”. The voltage application period t is set at 12 ms to obtain the gray level “3”. The voltage application period t is set at 17 ms to obtain the gray level “4”. The voltage application period t is set at 23 ms to obtain the gray level “5”. The voltage application period t is set at 32 ms to obtain the gray level “6”. The voltage application period t is set at 42 ms to obtain the gray level “7”.

When the voltage Vp applied to the liquid crystal 3 is V, the voltage application period t is set at 0 ms to obtain the gray level “0”. The voltage application period t is set at 40 ms to obtain the gray level “1”. The voltage application period t is set at 70 ms to obtain the gray level “2”. The voltage application period t is set at 100 ms to obtain the gray level “3”. The voltage application period t is set at 130 ms to obtain the gray level “4”. The voltage application period t is set at 155 ms to obtain the gray level “5”. The voltage application period t is set at 185 ms to obtain the gray level “6”. The voltage application period t is set at 220 ms to obtain the gray level “7”.

As thus described, the voltage application period t to obtain a desired gray level must be set longer, the lower the voltage Vp applied to the liquid crystal 3. The conditions for voltage application to the liquid crystal 3 shown in FIG. 6 are merely an example. The conditions for voltage application to the liquid crystal 3 depend on factors such as the physical properties of the cholesteric liquid crystal and the temperature at which the liquid crystal is driven.

Referring to FIG. 6, a mark “/” at the top left corner of a box showing a voltage application period t indicates that the amount of image sticking can be kept at 1.5% or less when the liquid crystal 3 is driven for the voltage application period t. Similarly, a mark “//” in a box indicates that the amount of image sticking can be kept 2.5% or less when the liquid crystal is driven for the voltage application period t shown in the box. When a box is marked with neither “/” nor “//”, it means that the amount of image sticking exceeds 2.5% when the liquid crystal is driven for the voltage application period t shown in the box.

In the example shown in FIG. 6, in the case of applied voltage Vp of 20 V, the amount of image sticking can be kept at 1.5% or less when the voltage application period t is set at 0 ms to obtain the gray level “0” and 12 ms to obtain the gray level “7”. Similarly, in the case that the applied voltage Vp is 15 V, the amount of image sticking can be kept at 1.5% or less when the voltage application period t is set at 0 ms to obtain the gray level “0”, and 42 ms to obtain the gray level “7”. In the case that the applied voltage Vp is 10 V, the amount of image sticking can be kept 1.5% or less when the voltage application period t is set at any of the values to obtain all the gray levels “0” to “7”.

The amount of image sticking can be kept at 2.5% or less at the applied voltage Vp of 20 V, when the voltage application period t is set at 1 ms to obtain the gray level “1” and 8.5 ms to obtain the gray level “6” in addition to the values of the voltage application period t marked with “/” at the top left corner of the respective boxes. Similarly, in the case that the applied voltage Vp is 15 V, the amount of image sticking can be kept at 2.5% or less when the voltage application is set at 3 ms to obtain the gray level “1”, 7 ms to obtain the gray level “2”, 23 ms to obtain the gray level “5”, and 32 ms to obtain the gray level 6.

Referring to FIGS. 4 and 5 again, a scan electrode driving circuit 25 carrying scan electrode driver ICs for driving the plurality of scan electrodes 17 is connected to the top substrate 7 of the liquid crystal display panel 6. A data electrode driving circuit 27 carrying data electrode driver ICs for driving the plurality of data electrodes 19 is connected to the bottom substrate 9.

The scan electrode driving circuit 25 performs selection from among the scan electrodes 17(i) having row numbers i=1 to m (=8) in a sequentially manner with the row under selection shifted one at a time based on a scan start signal output from a control section 23. A select signal is output to the i-th rows of scan electrodes 17(i) thus selected, and a non-select signal is output to the other scan electrodes 17. That is, the circuit performs what is called line sequential driving.

Based on a predetermined signal output from the control section 23, the data electrode driving circuit 27 outputs image data signals associated with pixels 12(i, 1) to 12(i, n(=8)) on the i-th rows of scan electrodes 17(i) thus selected to n data electrodes 19 having column numbers j=1 to n, respectively.

### (Timing Chart for Voltage Application to Drive Liquid Crystal)

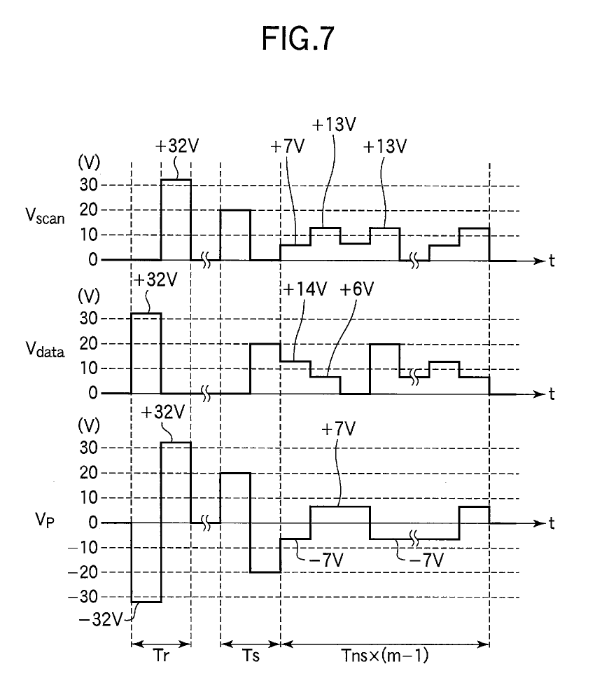

A timing chart for voltage application used in a method of driving the liquid crystal display element 1 in the present mode of the invention will now be described with reference to FIGS. 7 to 10. A scan electrode Vscan output from the scan electrode driving circuit 25 to the scan electrode 17(i) of an i-th row is shown in the top part of each of FIGS. 7 to 10. A data voltage Vdata output from the data electrode driving circuit 27 to the data electrode 19(j) of a j-th column is shown in the middle part. A voltage Vp applied to the liquid crystal 3 at the pixel 12(i,j) is shown in the bottom part. In each part of FIGS. 7 to 10, the horizontal axis represents time (t), and the vertical axis represents voltage levels (V).

FIG. 7 shows exemplary driving waveforms for driving the pixel 12(1,1) in the first row and the first column of the display screen. In this example, the liquid crystal 3 is reset to the planar state (gray level “0”) and is thereafter set in the focal conic state (gray level “7”) using the voltage applying conditions including an applied voltage Vp of 20 V as shown in FIG. 6.

First, in a period Tr/2 that is a first half of a reset period Tr (=12 ms), a scan voltage Vscan=0 V is applied to the scan electrode 17(1), and a data voltage Vdata=+32 V is applied to the data electrode 19(1). Next, in another period Tr/2 that is a second half of the reset period Tr, a scan voltage Vscan=+32 V is applied to the scan electrode 17(1), and a data voltage Vdata=0 V is applied to the data electrode 19(1). Thus, a reset pulse voltage Vp=Vscan−Vdata=+32 V is applied to the liquid crystal 3 at the pixel 12(1,1) during the reset period Tr. The helical structure of the cholesteric liquid crystal molecules is completely decomposed as a result of the application of the reset pulse voltage, and the liquid crystal enters a homeotropic state in which all liquid crystal molecules follow the direction of the electric field thus applied. Next, the scan voltage Vscan and the data voltage Vdata are abruptly nullified immediately after the reset period Tr to make the voltage Vp zero, and the liquid crystal 3 at the pixel 12(1,1) therefore enters the planar state (gray level “0”).

Next, in a period Ts/2 that is a first half of a selection period Ts (=12 ms), a scan voltage Vscan=+20 V (select signal) is applied to the scan electrode 17(1), and a data voltage Vdata=0 V is applied to the data electrode 19(1). Then, in the other period Ts/2 that is a second half of a selection period Ts (=12 ms), a scan voltage Vscan=0 V (select signal) is applied to the scan electrode 17(1), and a data voltage Vdata=+20 V is applied to the data electrode 19(1). Thus, a pulse voltage Vp=±20 V for the gray level “7” lower than ±32 V is applied to the liquid crystal 3 at the pixel 12(1,1) for a voltage application period t=12 ms during the selection period Ts. When a relatively weak electric field is thus generated in the cholesteric liquid crystal by applying the voltage of ±20 V lower than the voltage of ±32 V resulting in the planar state, the helical structure of the liquid crystal molecules will not be completely decomposed. When the voltage Vp applied to the liquid crystal changes into a value in the range from 0 to ±7 V immediately after the selection period Ts to make the electric field substantially zero abruptly, the liquid crystal 3 at the pixel 12(1,1) enters the focal conic state (gray level “7”). Thus, the gray level value of the pixel can be changed from the gray level “0” to the gray level “7”.

Next, in a period Tns/2 that is a first half of a non-selection period Tns (=12 ms), a scan voltage Vscan=+7 V (non-select signal) is applied to the scan electrode 17(1), and a data voltage Vdata of, for example, +14 V is applied to the data electrode 19(1). Then, in another period Tns/2 that is a second half of the non-selection period, a scan voltage Vscan=+13 V (non-select signal) is applied to the scan electrode 17(1), and a data voltage of, for example, +6 V is applied to the data electrode 19(1). Thus, a state-holding pulse voltage Vp which is as lows as ±7 V at the maximum is applied to the liquid crystal 3 at the pixel 12(1,1) during the non-selection period Tns. As a result, no change occurs in the state of the cholesteric liquid crystal during the non-selection period Ts, and the gray level of the pixel is therefore kept unchanged. The operation in the non-selection period Tns is repeated (m−1) times in one frame period.

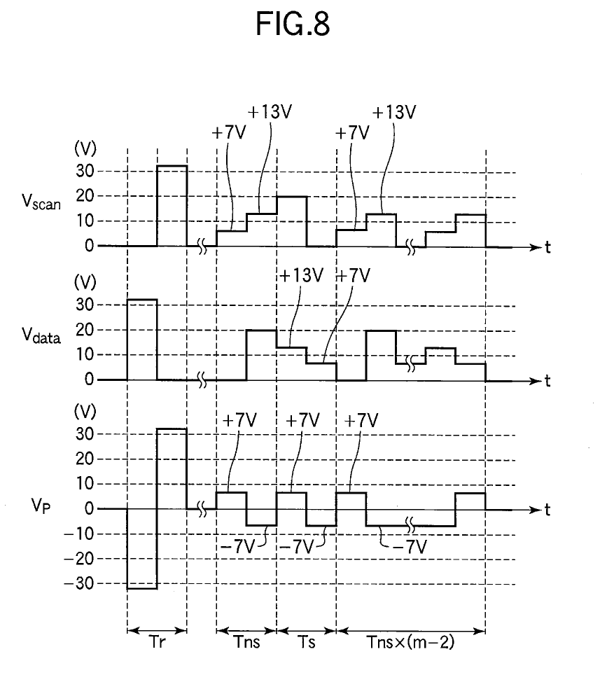

FIG. 8 shows exemplary driving waveforms for keeping the liquid crystal 3 at the pixel 12(2,1) in the second row and the first column of the display screen in the planar state (gray level “0”) after resetting the same. A reset operation performed during a reset period Tr (=12 ms) will not be described because it is the same as the operation shown in FIG. 7. A non-select operation associated with the scan electrode 17(2) constituting the second row carried out when the scan electrode 17(1) constituting the first row is selected and when the scan electrodes 17(i=3 to m) constituting the third to m-th row are selected will not be described because it is similar to the operation shown in FIG. 7.

Referring to FIG. 8, in a period Ts/2 that is the first half of a select period Ts (=12 ms), a scan voltage Vscan=+20 V (select signal) is applied to the scan electrode 17(2), and a data voltage Vdata=+13 V is applied to the data electrode 19(1). Then, in a period Ts/2 that is a second half of the select period Ts, a scan voltage Vscan=0 V (select signal) is applied to the scan electrode 17(2), and a data voltage Vdata=+7 V is applied to the data electrode 19(1). Thus, a state-holding pulse voltage Vp which is as low as ±7 V at the maximum is applied to the liquid crystal 3 at the pixel 12(2,1), during the selection period Ts. Thus, no change occurs in the state of the cholesteric liquid crystal in the select period Ts, and the planar state (gray level “0”) is maintained.

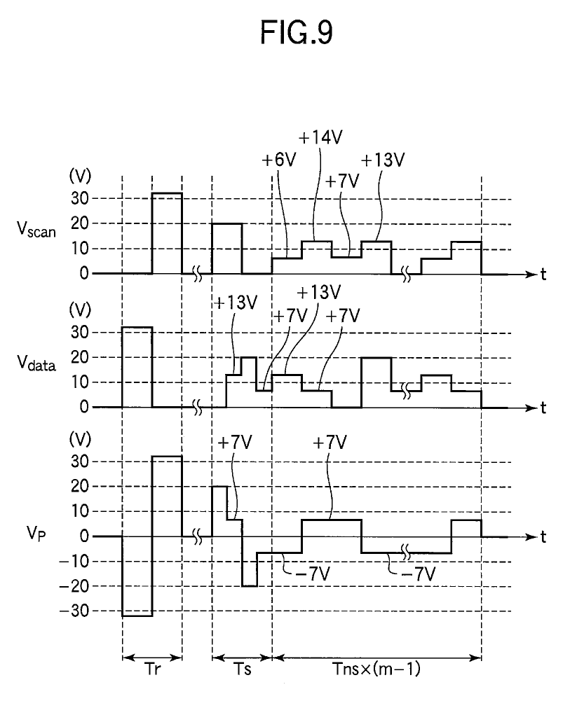

FIG. 9 shows exemplary driving waveforms for driving the pixel 12(1,1) in the first row, and the figure specifically shows driving waveforms for obtaining an intermediate state (gray level “5”) after resetting the liquid crystal 3 to the planar state (gray level “0”). A reset operation performed in a reset period Tr (=12 ms) and a non-select operation associated with the scan electrode 17(1) constituting the first row performed when the scan electrodes 17(i=2 to m) constituting the second to m-th rows are selected will not be described because those operations are similar to the operations described with reference to FIG. 7.

A scan voltage Vscan=+20 V (select signal) is applied to the scan electrode 17(1) in a period Ts/2 that is a first half of a select period Ts (=12 ms). A data voltage Vdata=0 V is applied to the data electrode 19(1) in a period Ts/4 that is a first half of the first half Ts/2 of the select period Ts. Then, a data voltage Vdata=+13V is applied in a subsequent period Ts/4. Thus, an applied voltage Vp=+20 V is applied to the liquid crystal 3 for a voltage application period t=Ts/4=3 (ms) in the first half Ts/2 of the select period Ts, and an applied voltage Vp=+7 V is thereafter applied to the liquid crystal 3 only for a voltage application period t=Ts/4=3 (ms).

A scan voltage Vscan=0 V (select signal) is applied to the scan electrode 17(1) in another period Ts/2 that is a second half of the select period Ts. A data voltage Vdata=+20 V is applied to the data electrode 19(1) during a period Ts/4 that is a first half of the second half Ts/2 of the select period Ts. Then, a data voltage Vdata=+7 V is applied in a subsequent period Ts/4. Thus, in the second half Ts/2 of the select period Ts, an applied voltage Vp=−20 V is applied to the liquid crystal 3 only for a voltage application period t=Ts/4=3 (ms), and an applied voltage Vp=−7 V is then applied to the liquid crystal 3 only for a voltage application period t=Ts/4=3 (ms).

As a result, a pulse voltage Vp=±20 V for the gray level “5” is applied to the liquid crystal 3 at the pixel 12(1,1) for a voltage application period t=6 (ms) within the selection period Ts to display the gray level “5” at the pixel 12(1,1).

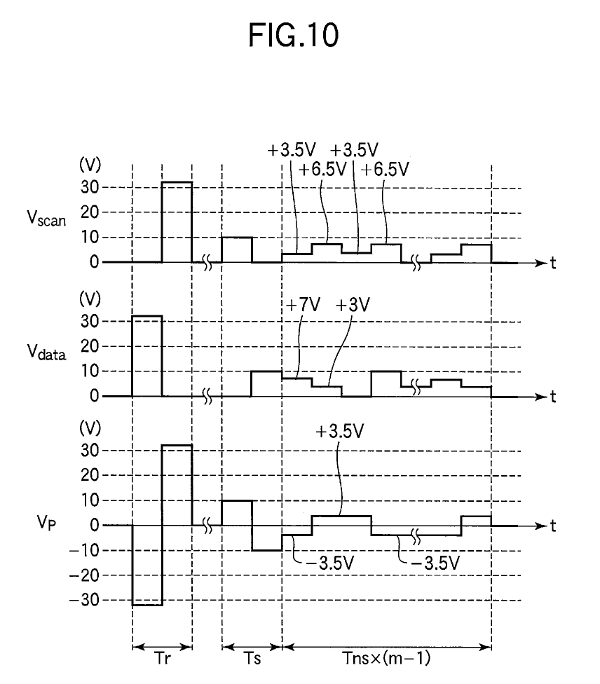

FIG. 10 shows exemplary driving waveforms for driving the pixel 12(1,1) in the first row, and the figure specifically shows driving waveforms for obtaining the focal conic state (gray level “7”) using the voltage applying conditions including an applied voltage Vp=10 V shown in FIG. 10 after resetting the liquid crystal 3 to the planar state (gray level “0”). A reset operation performed in a reset period Tr (=12 ms) will not be described because it is similar to the operation described above with reference to FIG. 7.

First, in a period Ts/2 that is a first half of a select period Ts (=220 ms), a scan voltage Vscan=+10 V (select signal) is applied to the scan electrode 17(1), and a data voltage Vdata=0 V is applied to the data electrode 19(1). Then, in another period Ts/2 that is a second half of the select period, a scan voltage Vscan=0 V (select signal) is applied to the scan electrode 17(1), and a data voltage Vdata=+10 V is applied to the data electrode 19(1). Thus, a pulse voltage Vp=±10 V for the gray level “7” lower than ±32 V is applied to the liquid crystal 3 at the pixel 12(1,1) only for a voltage application period t=220 ms during the select period Ts. When the voltage of ±10 V lower than the voltage of ±32 V resulting in the planar state is applied to generate a relatively weak electric field in the cholesteric liquid crystal, the helical structure of the liquid crystal molecules will not be completely decomposed. When the voltage Vp applied to the liquid crystal changes into a value in the range from 0 to ±4 V immediately after the selection period Ts to make the electric field substantially zero abruptly, the liquid crystal 3 at the pixel 12(1,1) enters the focal conic state (gray level “7”). Thus, the gray level value of the pixel can be changed from the gray level “0” to the gray level “7”.

Next, in a period Tns/2 that is a first half of a non-selection period Tns (=220 ms), a scan voltage Vscan=+3.5 V (non-select signal) is applied to the scan electrode 17(1), and a data voltage Vdata of, for example, +7 V is applied to the data electrode 19(1). Then, in another period Tns/2 that is a second half of the non-selection period, a scan voltage Vscan=+6.5 V (non-select signal) is applied to the scan electrode 17(1), and a data voltage of, for example, +3 V is applied to the data electrode 19(1). Thus, a state-holding pulse voltage Vp which is as lows as ±3.5 V at the maximum is applied to the liquid crystal 3 at the pixel 12(1,1) during the non-selection period Tns. As a result, no change occurs in the state of the cholesteric liquid crystal during the non-selection period Ts, and the gray level of the pixel is therefore kept unchanged. The operation in the non-selection period Tns is repeated (m−1) times in one frame period.

### (Method of Driving Liquid Crystal Display Element)

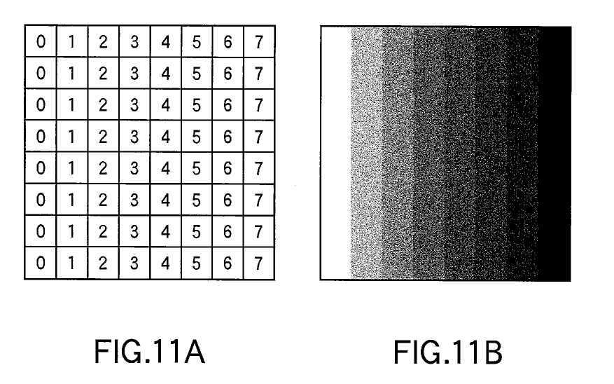

A method of driving the liquid crystal display element 1 in the present mode of the invention will now be described with reference to FIGS. 11A to 17E. FIGS. 11A and 11B show pixels 12(i,j) arranged in the form of a matrix having i (=8) rows and j (=8) columns on the display screen shown in FIG. 4. In FIG. 11A, each pixel 12(i,j) is represented by a square box, and the figure in the box represents a gray level value. The illustration in FIG. 11A shows a state in which the gray level “0” is displayed in the pixels 12(1,1) to 12(8,1) in the leftmost column having a column number j=1; the gray level “1” is displayed in the pixels 12(1,2) to 12(8,2) in the column having a column number j=2; the gray level “2” is displayed in the pixels 12(1,3) to 12(8,3) in the column having a column number j=3; the gray level “3” is displayed in the pixels 12(1,4) to 12(8,4) in the column having a column number j=4; the gray level “4” is displayed in the pixels 12(1,5) to 12(8,5) in the column having a column number j=5; the gray level “5” is displayed in the pixels 12(1,6) to 12(8,6) in the column having a column number j=6; the gray level “6” is displayed in the pixels 12(1,7) to 12(8,7) in the column having a column number j=7; and the gray level “7” is displayed in the pixels 12(1,8) to 12(8,8) in the column having a column number j=8.

FIG. 11B shows an actual state of display resulting from the state shown in FIG. 11A. The image shown in FIG. 11B is perceived as stripe-like gray level patterns which extend in the vertical direction of the display screen and which are in parallel with each other in the horizontal direction of the screen. In this example, the gray level patterns shown in FIG. 11B constitute an image which is to be displayed after resetting the liquid crystal at the pixels to the planar state.

First, the method of driving the liquid crystal display element 1 will be described using a common case in which an image is displayed at N gray levels (N represents 3 or a greater natural number).

(1) The control section 23 of the liquid crystal display element 1 receives gray level data for one frame (display screen) from an external system and stores the data in frame buffers (storage section) which are not shown. The gray level data for one frame is m×n pieces of data for all pixels.

(2) Next, the control section 23 divides a gray level “i” into M sub gray levels to display the gray level i (0≦i≦N−1) by performing a superimposing rewrite process M times (M≧2).

(3) Dividing conditions applied to the division of a gray level “i” into M sub gray levels are as follows.

(a) Let us assume that the M sub gray levels of the gray level “i” are represented by “i1”, “i2”, . . . “i(m−1)”, and “im”.

Then, the sum of the M sub gray levels is (i1+i2+ . . . +i(m−1)+im)=i.

(b) The gray level is divided such that sa<s(a+1) and/or t(a+1)<ta holds true where:

sa represents a maximum gray level within a gray level range expressed by 0≦i<(N−1)/2 and ta represents a minimum gray level within a gray level range expressed by (N−1)/2≦i≦(N−1), the gray level ranges being defined for a gray level obtained as a result of the first to a-th (1≦a<M) superimposing rewrite processes; and

s(a+1) represents a maximum gray level within a gray level range expressed by 0≦i≦(N−1)/2 and t(a+1) represents a minimum gray level within a gray level range expressed by (N−1)/2≦i≦(N−1), the gray level ranges being defined for a gray level obtained as a result of the (a+1)-th rewrite process performed after the a-th process.

(c) The first rewrite process must be performed by selecting such a gray level value that the amount of image sticking will not exceed 2.5% even if the voltage is applied to the liquid crystal for a relatively short voltage application period.

(4) Next, the control section 23 writes the sub gray levels in M respective frame buffers.

(5) Next, the control section 23 determines first to M-th sets of voltage applying conditions used at the first to M-th rewrite processes, respectively. The first to M-th sets of voltage applying conditions include applied voltages Vp descending in magnitude in the order in which the sets of conditions are listed. That is, each rewrite process has a rewriting period longer than that of the preceding process.

(6) Next, the control section 23 performs the first to M-th rewrite processes.

(7) When the (a+1)-th rewrite process is performed to superimpose a sub gray level i(a+1) at a pixel having a gray level (i1+i2+ . . . +i(a−1)+ia) obtained at the a-th process, the voltage application period included in the voltage applying conditions used for superimposing the sub gray level i(a+1) at the (a+1)-th rewrite process is a difference between the voltage application period t to obtain the gray level i(a+1) and the voltage application period t to obtain the gray level (i1+i2+ . . . +i(a−1)+ia).

(8) As thus described, a preliminary image can be displayed in a short time, and a complete image can be displayed with image sticking suppressed.

Referring to the dividing conditions, there are two gray level ranges defined using the gray level (N−1)/2 as a boundary. For example, the reason is that amounts of image sticking are substantially symmetrically distributed about the gray level (N−1)/2 (=3.5) under the voltage applying conditions shown in FIG. 6. When the distribution of image sticking amounts is shifted to result in a change in the position of the axis of symmetry, the two gray level ranges may obviously be defined differently using an appropriate boundary.

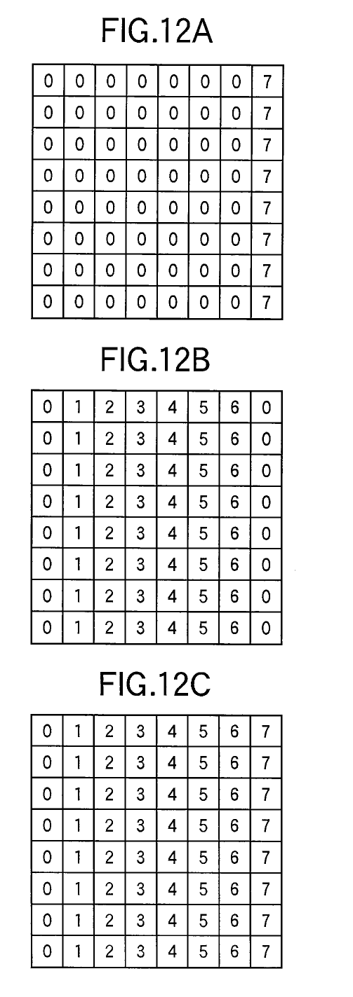

The method of driving the liquid crystal display element 1 to display an image or pattern as shown in FIGS. 11A and 11B will now be described using an instance shown in FIGS. 12A to 12C.

(1) The control section 23 of the liquid crystal display element 1 receives gray level data for one frame (display screen) from an external system and stores the data in frame buffers (storage section) which are not shown. The gray level data for one frame is 8×8=64 pieces of data for all pixels.

(2) Next, the control section 23 divides a gray level “i” into two sub gray levels to display the gray level i (0≦i≦7) by performing a superimposing rewrite process twice. Two types of voltage applying conditions, i.e., first and second sets of voltage applying conditions are determined accordingly. An applied voltage Vp included in the second voltage applying conditions is lower than that in the first voltage applying conditions. In this instance, the first voltage applying conditions include an applied voltage Vp=20 V, and the second voltage applying conditions include an applied voltage Vp=10 V.

(3) Dividing conditions applied to the division of a gray level “i” into two sub gray levels are as follows.

(a) Let us assume that the two sub gray levels of the gray level “i” are represented by “i1” and “i2”. Then, the sum of the two sub gray levels is (i1+i2)=i.

(b) The gray level is divided such that s1<s2 and/or t2<t1 holds true where:

s1 represents a maximum gray level within a gray level range expressed by 0≦i<3.5 and t1 represents a minimum gray level within a gray level range expressed by 3.5≦i≦7, the gray level ranges being defined for a gray level obtained as a result of the first rewrite process; and

s2 represents a maximum gray level within a gray level range expressed by 0≦i<3.5 and t2 represents a minimum gray level within a gray level range expressed by 3.5≦i≦7, the gray level ranges being defined for a gray level obtained as a result of the second rewrite process performed after the first process.

(c) The first rewrite process must be performed by selecting such a gray level value that the amount of image sticking will not exceed 2.5% even if the voltage is applied to the liquid crystal for a relatively short voltage application period.

The gray level obtained after the second superimposing rewrite process mentioned in the above item (b) is a target gray level. Therefore, in the case of the image or pattern in FIGS. 11A and 11B, s2=3, and t2=4.

Therefore, s1=any of 0, 1, and 2 and/or t1=any of 5, 6, and 7 must be true. Further, according to the condition specified in the above item (c), s1=0 or 1 and/or t1=6 or 7 must be true from the table shown in FIG. 6. This instance is based on an assumption that s1=0 and t1=7.

Therefore, according to the above item (a), gray levels are divided as listed below where gray level “i”=sub gray level “i1”+sub gray level “i2”.

gray level “0”=sub gray level “0”+sub gray level “0”
gray level “1”=sub gray level “0”+sub gray level “1”
gray level “2”=sub gray level “0”+sub gray level “2”
gray level “3”=sub gray level “0”+sub gray level “3”
gray level “4”=sub gray level “0”+sub gray level “4”
gray level “5”=sub gray level “0”+sub gray level “5”
gray level “6”=sub gray level “0”+sub gray level “6”
gray level “7”=sub gray level “7”+sub gray level “0”

(4) Next, the control section 23 writes the sub gray levels “i1” and the sub gray levels “i2” in first and second frame buffers, respectively.

(5) Next, the control section 23 writes the sub gray levels stored in the first frame buffer in the respective pixels using an applied voltage Vp=20 V for the voltage application periods shown in FIG. 6 (see FIG. 12A). At the rewrite process shown in FIG. 12A, the sub gray levels “0” and “7” are written using the applied voltage Vp=20 V shown in FIG. 6 after the liquid crystal is reset. The rewriting period required per scan electrode is 12 ms which is the time required to write the gray level “7” at the applied voltage Vp=20 V. Therefore, a preliminary image having preliminary gray levels is displayed in about 96 ms (=12 (ms)×8 (electrodes)).

(6) Then, the control section 23 writes the sub gray levels stored in the second frame buffer in the respective pixels using an applied voltage Vp=10 V for the voltage application periods shown in FIG. 6 (see FIG. 12B). At the rewrite process shown in FIG. 12B, the sub gray levels “0” and “1” to “6” are written using the applied voltage Vp=10 V shown in FIG. 6. The rewriting period required per scan electrode is 185 ms which is the time required to write the gray level “6” at the applied voltage Vp=10 V. Therefore, the second rewrite process takes about 1480 ms (=185 (ms)×8 (electrodes)).

(7) Thus, a preliminary image can be displayed in a short time, and a complete image can be displayed with image sticking suppressed (see FIG. 12C).

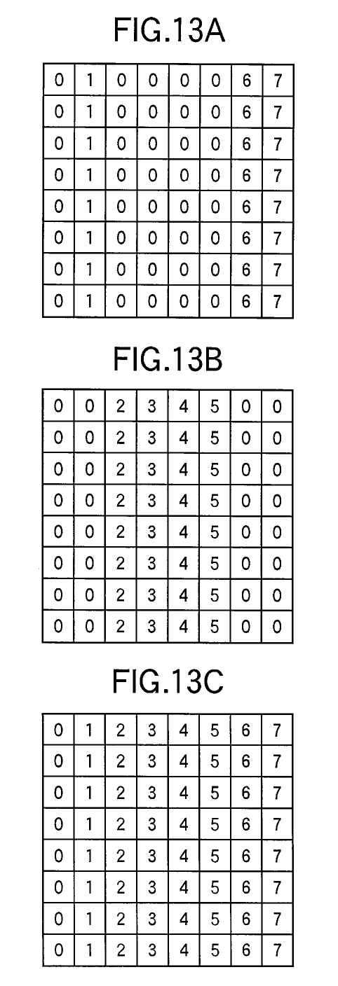

The method of driving the liquid crystal display element 1 to display an image or pattern as shown in FIGS. 11A and 11B will now be described using another instance shown in FIGS. 13A to 13C. Steps identical to the steps described above with reference to FIGS. 12A to 12C will be omitted in the following description.

(1) The control section 23 divides a gray level “i” into two sub gray levels to display the gray level i (0≦i≦7) by performing a superimposing rewrite process twice.

(2) According to the dividing conditions, the maximum gray level s2 and the minimum gray level t2 are set at 3 and 4, respectively. Then, s1=any of 0, 1, and 2 and/or t1=any of 5, 6, and 7 must be true. Further, according to the condition specified in the above item (c), s1=0 or 1 and/or t1=6 or 7 must be true from the table shown in FIG. 6. This instance is based on an assumption that s1=1 and t1=6.

Therefore, according to the above item (a), gray levels are divided as listed below where gray level “i”=sub gray level “i1”+sub gray level “i2”.

gray level “0”=sub gray level “0”+sub gray level “0”
gray level “1”=sub gray level “1”+sub gray level “0”
gray level “2”=sub gray level “0”+sub gray level “2”
gray level “3”=sub gray level “0”+sub gray level “3”
gray level “4”=sub gray level “0”+sub gray level “4”
gray level “5”=sub gray level “0”+sub gray level “5”
gray level “6”=sub gray level “6”+sub gray level “0”
gray level “7”=sub gray level “7”+sub gray level “0”

(3) Next, the control section 23 writes the sub gray levels stored in the first frame buffer in the respective pixels using an applied voltage Vp=20 V for the voltage application periods shown in FIG. 6 (see FIG. 13A). At the rewrite process shown in FIG. 13A, the sub gray levels “0”, “6”, and “7” are written using the applied voltage Vp=20 V shown in FIG. 6 after the liquid crystal is reset. The rewriting period required per scan electrode is 12 ms which is the time required to write the gray level “7” at the applied voltage Vp=20 V. Therefore, a preliminary image having preliminary gray levels is displayed in about 96 ms (=12 (ms)×8 (electrodes)).

(4) Then, the control section 23 writes the sub gray levels stored in the second frame buffer in the respective pixels using an applied voltage Vp=10 V for the voltage application periods shown in FIG. 6 (see FIG. 13B). At the rewrite process shown in FIG. 13B, the sub gray levels “0” and “2” to “5” are written using the applied voltage Vp=10 V shown in FIG. 6. The rewriting period required per scan electrode is 155 ms which is the time required to write the gray level “5” at the applied voltage Vp=10 V. Therefore, the second rewrite process takes about 1240 ms (=155 (ms)×8 (electrodes)).

(5) Thus, a preliminary image can be displayed in a short time, and a complete image can be displayed with image sticking suppressed (see FIG. 13C).

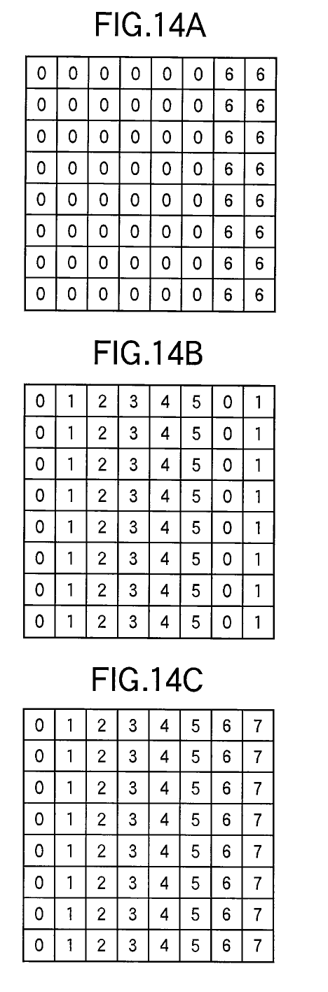

The method of driving the liquid crystal display element 1 to display an image or pattern as shown in FIGS. 11A and 11B will now be described using still another instance shown in FIGS. 14A to 14C. Steps identical to the steps described above with reference to FIGS. 12A to 12C will be omitted in the following description.

(1) The control section 23 divides a gray level “i” into two sub gray levels to display the gray level i (0≦i≦7) by performing a superimposing rewrite process twice.

(2) According to the dividing conditions, the maximum gray level s2 and the minimum gray level t2 are set at 3 and 4, respectively. Then, s1=any of 0, 1, and 2 and/or t1=any of 5, 6, and 7 must be true. Further, according to the condition specified in the above item (c), s1=0 or 1 and/or t1=6 or 7 must be true from the table shown in FIG. 6. This instance is based on an assumption that s1=0 and t1=6.

Therefore, according to the above item (a), gray levels are divided as listed below where gray level “i”=sub gray level “i1”+sub gray level “i2”.

gray level “0”=sub gray level “0”+sub gray level “0”
gray level “1”=sub gray level “0”+sub gray level “1”
gray level “2”=sub gray level “0”+sub gray level “2”
gray level “3”=sub gray level “0”+sub gray level “3”
gray level “4”=sub gray level “0”+sub gray level “4”
gray level “5”=sub gray level “0”+sub gray level “5”
gray level “6”=sub gray level “6”+sub gray level “0”
gray level “7”=sub gray level “6”+sub gray level “1”

(3) Next, the control section 23 writes the sub gray levels stored in the first frame buffer in the respective pixels using an applied voltage Vp=20 V for the voltage application periods shown in FIG. 6 (see FIG. 14A). At the rewrite process shown in FIG. 14A, the sub gray levels “0” and “6” are written using the applied voltage Vp=20 V shown in FIG. 6 after the liquid crystal is reset. The rewriting period required per scan electrode is 8.5 ms which is the time required to write the gray level “6” at the applied voltage Vp=20 V. Therefore, a preliminary image is displayed in about 68 ms (=8.5 (ms)×8 (electrodes)).

(4) Then, the control section 23 writes the sub gray levels stored in the second frame buffer in the respective pixels using an applied voltage Vp=10 V for the voltage application periods shown in FIG. 6 (see FIG. 14B). At the rewrite process shown in FIG. 14B, the sub gray levels “0” and “1” to “5” are written using the applied voltage Vp=10 V shown in FIG. 6. The rewriting period required per scan electrode is 155 ms which is the time required to write the gray level “5” at the applied voltage Vp=10 V. Therefore, the second rewrite process takes about 1240 ms (=155 (ms)×8 (electrodes)).

(5) When the gray level “7” is obtained at the second process by superimposing the sub gray level “1” on the pixels having the sub gray level “6” obtained at the first process, the voltage application period of the voltage applying conditions used at the second rewrite process is a difference t=220−185=35 ms between the voltage application period t=220 ms to obtain the gray level “7” and the voltage application period t=185 ms to obtain the gray level “6”.

(6) Thus, a preliminary image can be displayed in a short time, and a complete image can be displayed with image sticking suppressed (see FIG. 14C).

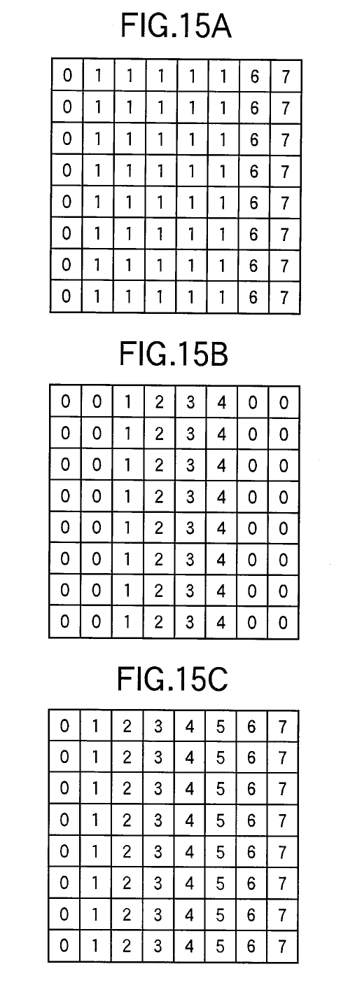

The method of driving the liquid crystal display element 1 to display an image or pattern as shown in FIGS. 11A and 11B will now be described using still another instance shown in FIGS. 15A to 15C. Steps identical to the steps described above with reference to FIGS. 12A to 12C and FIGS. 14A to 14C will be omitted in the following description.

(1) The control section 23 divides a gray level “i” into two sub gray levels to display the gray level i (0≦i≦7) by performing a superimposing rewrite process twice.

(2) According to the dividing conditions, the maximum gray level s2 and the minimum gray level t2 are set at 3 and 4, respectively. Then, s1=any of 0, 1, and 2 and/or t1=any of 5, 6, and 7 must be true. Further, according to the condition specified in the above item (c), s1=0 or 1 and/or t1=6 or 7 must be true from the table shown in FIG. 6. This instance is based on an assumption that s1=1 and t1=6.

Therefore, according to the above item (a), gray levels are divided as listed below where gray level “i”=sub gray level “i1”+sub gray level “i2”.

gray level “0”=sub gray level “0”+sub gray level “0”
gray level “1”=sub gray level “1”+sub gray level “0”
gray level “2”=sub gray level “1”+sub gray level “1”
gray level “3”=sub gray level “1”+sub gray level “2”
gray level “4”=sub gray level “1”+sub gray level “3”
gray level “5”=sub gray level “1”+sub gray level “4”
gray level “6”=sub gray level “6”+sub gray level “0”
gray level “7”=sub gray level “7”+sub gray level “0”

(3) Next, the control section 23 writes the sub gray levels stored in the first frame buffer in the respective pixels using an applied voltage Vp=20 V for the voltage application periods shown in FIG. 6 (see FIG. 15A). At the rewrite process shown in FIG. 15A, the sub gray levels “0”, “1”, “6”, and “7” are written using the applied voltage Vp=20 V shown in FIG. 6 after the liquid crystal is reset. The rewriting period required per scan electrode is 12 ms which is the time required to write the gray level “7” at the applied voltage Vp=20 V. Therefore, a preliminary image is displayed in about 96 ms (=12 (ms)×8 (electrodes)).

(4) Then, the control section 23 writes the sub gray levels stored in the second frame buffer in the respective pixels using an applied voltage Vp=10 V for the voltage application periods shown in FIG. 6 (see FIG. 15B). At the rewrite process shown in FIG. 15B, the sub gray levels “0” and “1” to “4” are written using the applied voltage Vp=10 V shown in FIG. 6.

(5) When the gray level “2” is obtained at the second process by superimposing the sub gray level “1” on the pixels having the sub gray level “1” obtained at the first process, the voltage application period of the voltage applying conditions used at the second rewrite process is a difference t=70−40=30 ms between the voltage application period t=70 ms to obtain the gray level “2” and the voltage application period t=40 ms to obtain the gray level “1”.

Similarly, when the gray level “3” is obtained at the second process by superimposing the sub gray level “2” on the pixels having the sub gray level “1” obtained at the first process, the voltage application period of the voltage applying conditions used at the second rewrite process is a difference t=100−40=60 ms between the voltage application period t=100 ms to obtain the gray level “3” and the voltage application period t=40 ms to obtain the gray level “1”.

Similarly, when the gray level “4” is obtained at the second process by superimposing the sub gray level “3” on the pixels having the sub gray level “1” obtained at the first process, the voltage application period of the voltage applying conditions used at the second rewrite process is a difference t=130−40=90 ms between the voltage application period t=130 ms to obtain the gray level “4” and the voltage application period t=40 ms to obtain the gray level “1”.

Similarly, when the gray level “5” is obtained at the second process by superimposing the sub gray level “4” on the pixels having the sub gray level “1” obtained at the first process, the voltage application period of the voltage applying conditions used at the second rewrite process is a difference t=155−40=115 ms between the voltage application period t=155 ms to obtain the gray level “5” and the voltage application period t=40 ms to obtain the gray level “1”.

The rewriting period required per scan electrode is 115 ms which is the time required to write the sub gray level “4” at the applied voltage Vp=10 V. Therefore, the second rewrite process takes about 920 ms (=115 (ms)×8 (electrodes)).

(6) Thus, a preliminary image can be displayed in a short time, and a complete image can be displayed with image sticking suppressed (see FIG. 15C).

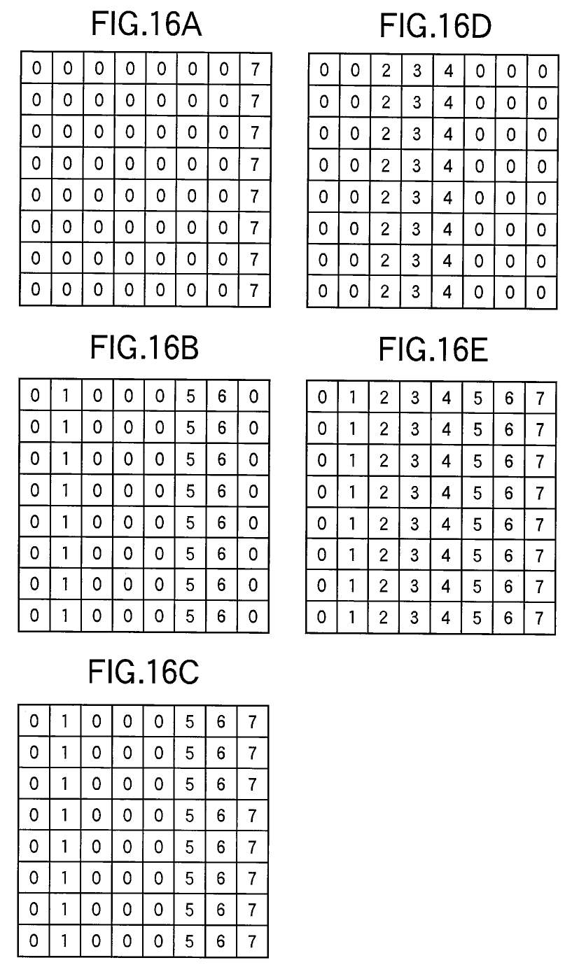

The method of driving the liquid crystal display element 1 to display an image or pattern as shown in FIGS. 11A and 11B will now be described using still another instance shown in FIGS. 16A to 16E. Steps identical to the steps described above with reference to FIGS. 12A to 12C, 14A to 14C, and FIGS. 15A to 15C will be omitted in the following description.

(1) The control section 23 of the liquid crystal display element 1 receives gray level data for one frame from an external system and stores the data in frame buffers which are not shown. The gray level data for one frame is 8×8=64 pieces of data for all pixels.

(2) Next, the control section 23 divides a gray level “i” into three sub gray levels to display the gray level i (0≦i≦7) by performing a superimposing rewrite process three times. Three types of voltage applying conditions, i.e., first to third sets of voltage applying conditions are determined accordingly. Applied voltages Vp included in the first, second, and third sets of voltage applying conditions have magnitudes descending in the order in which the sets of conditions are listed. In this instance, the first voltage applying conditions include an applied voltage Vp=20 V; the second voltage applying conditions include an applied voltage Vp=15 V; and the third voltage applying conditions include an applied voltage Vp=10 V.

(3) Dividing conditions applied to the division of a gray level “i” into three sub gray levels are as follows.

(a) Let us assume that the three sub gray levels of the gray level “i” are represented by “i1”, “i2”, and “i3”. Then, the sum of the three sub gray levels is (i1+i2+i3)=i.

(b) The gray level is divided such that s2<s3 and/or t3<t2 holds true where:

s2 represents a maximum gray level within a gray level range expressed by 0≦i<3.5 and t2 represents a minimum gray level within a gray level range expressed by 3.5≦i≦7, the gray level ranges being defined for a gray level obtained as a result of the second rewrite process; and

s3 represents a maximum gray level within a gray level range expressed by 0≦i<3.5 and t3 represents a minimum gray level within a gray level range expressed by 3.5≦i≦7, the gray level ranges being defined for a gray level obtained as a result of the third superimposing rewrite process performed after the second process.

(c) The gray level is divided such that s1<s2 and/or t2<t1 holds true where:

s1 represents a maximum gray level within a gray level range expressed by 0≦i<3.5 and t1 represents a minimum gray level within a gray level range expressed by 3.5≦i≦7, the gray level ranges being defined for a gray level obtained as a result of the first rewrite process; and

s2 represents a maximum gray level within a gray level range expressed by 0≦i<3.5 and t2 represents a minimum gray level within a gray level range expressed by 3.5≦i≦7, the gray level ranges being defined for a gray level obtained as a result of the second superimposing rewrite process performed after the first process.

(d) The first and the second rewrite processes must be performed by selecting such gray level values that the amount of image sticking will not exceed 2.5% even if the voltages are applied to the liquid crystal for relatively short voltage application periods.

The gray level obtained after the third superimposing rewrite process mentioned in the above item (b) is a target gray level. Therefore, in the case of the image or pattern in FIGS. 11A and 11B, s3=3, and t3=4.

Therefore, s2=any of 0, 1, and 2 and/or t2=any of 5, 6, and 7 must be true. Further, according to the condition specified in the above item (d), s1=0 or 1 and/or t1=6 or 7 must be true from the table shown in FIG. 6. This instance is based on an assumption that s1=0; t1=7; s2=1; t2=5; s3=3; and t3=4.

Therefore, according to the above item (a), gray levels are divided as listed below where gray level “i”=sub gray level “i1”+sub gray level “i2”+sub gray level “i3”.

gray level “0”=sub gray level “0”+sub gray level “0”+sub gray level “0”

gray level “1”=sub gray level “0”+sub gray level “1”+sub gray level “0”

gray level “2”=sub gray level “0”+sub gray level “0”+sub gray level “2”

gray level “3”=sub gray level “0”+sub gray level “0”+sub gray level “3”

gray level “4”=sub gray level “0”+sub gray level “0”+sub gray level “4”

gray level “5”=sub gray level “0”+sub gray level “5”+sub gray level “0”

gray level “6”=sub gray level “0”+sub gray level “6”+sub gray level “0”

gray level “7”=sub gray level “7”+sub gray level “0”+sub gray level “0”

(4) Next, the control section 23 writes the sub gray levels “i1”, the sub gray levels “i2”, and the sub gray levels “i3” in first, second, and third frame buffers, respectively.

(5) Next, the control section 23 writes the sub gray levels stored in the first frame buffer in the respective pixels using an applied voltage Vp=20 V for the voltage application periods shown in FIG. 6 (see FIG. 16A). At the rewrite process shown in FIG. 16A, the sub gray levels “0” and “7” are written using the applied voltage Vp=20 V shown in FIG. 6 after the liquid crystal is reset. The rewriting period required per scan electrode is 12 ms which is the time required to write the gray level “7” at the applied voltage Vp=20 V. Therefore, a preliminary image having preliminary gray levels is displayed in about 96 ms (=12 (ms)×8 (electrodes)).

(6) Then, the control section 23 superimposes the sub gray levels stored in the second frame buffer on the respective pixels using an applied voltage Vp=15 V for the voltage application periods shown in FIG. 6 (see FIG. 16B). At the rewrite process shown in FIG. 16B, the sub gray levels “0”, “1”, “5”, and “6” are written using the applied voltage Vp=V shown in FIG. 6. The rewriting period required per scan electrode is 32 ms which is the time required to write the gray level “6” at the applied voltage Vp=15 V. Therefore, the second rewrite process takes about 256 ms (=32 (ms)×8 (electrodes)).

(7) Thus, a preliminary image can be displayed in a short time, and an intermediate image can be displayed with image sticking suppressed (see FIG. 16C).

(8) Next, the control section 23 writes the sub gray levels stored in the third frame buffer in the respective pixels using an applied voltage Vp=10 V for the voltage application periods shown in FIG. 6 (see FIG. 16D). At the rewrite process shown in FIG. 16D, the sub gray levels “0”, “2”, “3”, and “4” are written using the applied voltage Vp=10 V shown in FIG. 6. The rewriting period required per scan electrode is 130 ms which is the time required to write the gray level “4” at the applied voltage Vp=10 V. Therefore, the third rewrite process takes about 1040 ms (=130 (ms)×8 (electrodes)). Thus, a complete image is displayed (see FIG. 16E).

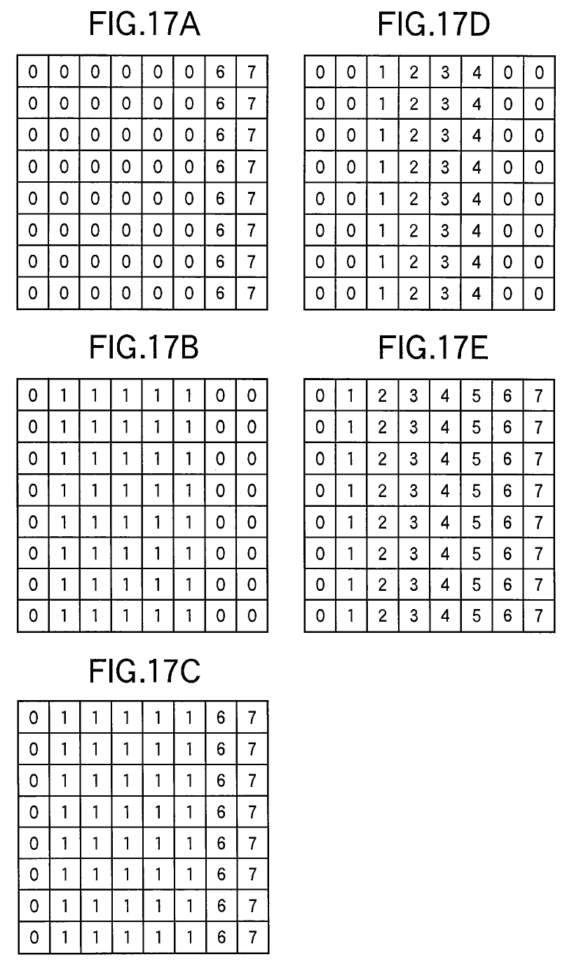

The method of driving the liquid crystal display element 1 to display an image or pattern as shown in FIGS. 11A and 11B will now be described using still another instance shown in FIGS. 17A to 17E. Steps identical to the steps described above with reference to FIGS. 16A to 16E will be omitted in the following description.

(1) The control section 23 divides a gray level “i” into three sub gray levels to display the gray level i (0≦i≦7) by performing a superimposing rewrite process three times.

(2) According to the dividing conditions, the maximum gray level s3 and the minimum gray level t3 are set at 3 and 4, respectively. Then, s2=any of 0, 1, and 2 and/or t2=any of 5, 6, and 7 must be true. Further, according to the condition specified in the above item (c), s1=0 or 1 and/or t1=6 or 7 must be true from the table shown in FIG. 6. This instance is based on an assumption that s1=0; t1=6; s2=1; t2=6; s3=3; and t3=4.

Therefore, according to the above item (a), gray levels are divided as listed below where gray level “i”=sub gray level “i1”+sub gray level “i2”+sub gray level “i3”.

gray level “0”=sub gray level “0”+sub gray level “0”+sub gray level “0”

gray level “1”=sub gray level “0”+sub gray level “1”+sub gray level “0”

gray level “2”=sub gray level “0”+sub gray level “1”+sub gray level “1”

gray level “3”=sub gray level “0”+sub gray level “1”+sub gray level “2”

gray level “4”=sub gray level “0”+sub gray level “1”+sub gray level “3”

gray level “5”=sub gray level “0”+sub gray level “1”+sub gray level “4”

gray level “6”=sub gray level “6”+sub gray level “0”+sub gray level “0”

gray level “7”=sub gray level “7”+sub gray level “0”+sub gray level “0”

(3) Next, the control section 23 writes the sub gray levels stored in the first frame buffer in the respective pixels using an applied voltage Vp=20 V for the voltage application periods shown in FIG. 6 (see FIG. 17A). At the rewrite process shown in FIG. 17A, the sub gray levels “0”, “6”, and “7” are written using the applied voltage Vp=20 V shown in FIG. 6 after the liquid crystal is reset. The rewriting period required per scan electrode is 12 ms which is the time required to write the gray level “7” at the applied voltage Vp=20 V. Therefore, a preliminary image having preliminary gray levels is displayed in about 96 ms (=12 (ms)×8 (electrodes)).

(4) Then, the control section 23 writes the sub gray levels stored in the second frame buffer in the respective pixels using an applied voltage Vp=15 V for the voltage application periods shown in FIG. 6 (see FIG. 17B). At the rewrite process shown in FIG. 17B, the sub gray levels “0” and “1” are written using the applied voltage Vp=15 V shown in FIG. 6. The rewriting period required per scan electrode is 3 ms which is the time required to write the gray level “1” at the applied voltage Vp=15 V. Therefore, the second rewrite process takes about 24 ms (=3 (ms)×8 (electrodes)).

(5) Thus, a preliminary image can be displayed in a short time, and an intermediate image can be displayed with image sticking suppressed (see FIG. 17C).

(6) Next, the control section 23 superimposes the sub gray levels stored in the third frame buffer on the respective pixels using an applied voltage Vp=10 V for the voltage application periods shown in FIG. 6 (see FIG. 17D). At the rewrite process shown in FIG. 17D, the sub gray levels “0”, “1”, “2”, “3”, and “4” are written using the applied voltage Vp=10 V shown in FIG. 6.

(7) When the gray level “2” is obtained at the third process by superimposing the sub gray level “1” on the pixels having the sub gray level “1” obtained at the second write process, the voltage application period of the voltage applying conditions used at the third rewrite process is a difference t=70−40=30 ms between the voltage application period t =70 ms to obtain the gray level “2” and the voltage application period t=40 ms to obtain the gray level “1”.

Similarly, when the gray level “3” is obtained at the third process by superimposing the sub gray level “2” on the pixels having the sub gray level “1” obtained at the second write process, the voltage application period of the voltage applying conditions used at the third rewrite process is a difference t=100−40=60 ms between the voltage application period t=100 ms to obtain the gray level “3” and the voltage application period t=40 ms to obtain the gray level “1”.

Similarly, when the gray level “4” is obtained at the third process by superimposing the sub gray level “3” on the pixels having the sub gray level “1” obtained at the second write process, the voltage application period of the voltage applying conditions used at the third rewrite process is a difference t=130−40=90 ms between the voltage application period t=130 ms to obtain the gray level “4” and the voltage application period t=40 ms to obtain the gray level “1”.

Similarly, when the gray level “5” is obtained at the third process by superimposing the sub gray level “4” on the pixels having the sub gray level “1” obtained at the second write process, the voltage application period of the voltage applying conditions used at the third rewrite process is a difference t=155−40=115 ms between the voltage application period t=155 ms to obtain the gray level “5” and the voltage application period t=40 ms to obtain the gray level “1”.

The rewriting period required per scan electrode is 115 ms which is the time required to write the gray level “4” at the applied voltage Vp=10 V. Therefore, the third rewrite process takes about 920 ms (=115 (ms)×8 (electrodes)). Thus, a complete image is displayed with image sticking suppressed (see FIG. 17E).

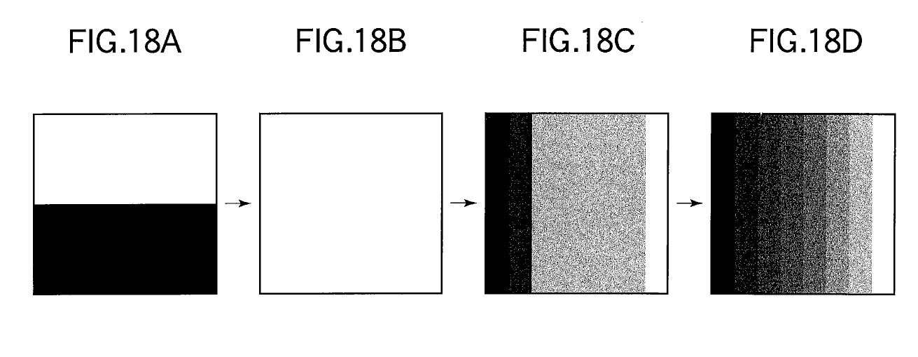

A description will now be made with reference to FIGS. 18A to 20E on embodiments of the invention in which an image is displayed using a liquid crystal display element 1 in the above-described mode of the invention.

### Embodiment 1

Each of FIGS. 18A to 18D shows a display screen of a liquid crystal display element 1.

First, as shown in FIG. 18A, an image or pattern was displayed for one week in a memorized display mode with the top half and the bottom half of the element in the planar state (state to reflect green) and the focal conic state (black state), respectively. Thereafter, a reset voltage of 36 V was applied to reset the liquid crystal to the planar state at all pixels, whereby green was displayed throughout the display screen (FIG. 18B). Thereafter, a voltage Vp=20 V was applied with the voltage application period varied within the range of about 1 ms to about 20 ms to set the element in a preliminary display state in which an image or pattern was displayed excluding some intermediate gray levels (FIG. 18C). Next, a voltage Vp=10 V was applied with the voltage application period varied within the range from about 40 ms to about 160 ms to perform an additional write in an superimposing mode. Thus, a gradation pattern including parts at intermediate gray levels was displayed (FIG. 18D). The present embodiment employs the same driving method as that described with reference to FIGS. 15A to 15C.

In the state shown in FIG. 18D, the reflectances of top and bottom regions divided at the center part of the screen were measured. A difference in the reflectances was measured between the top and bottom regions which were driven for display under the same liquid crystal driving conditions. The degree of image sticking on the screen was obtained by normalizing the difference with respect to the maximum reflectance of the element in the planar state. Reflectance was measured on light entering from a D65 light source at an angle of incidence of 30° using a spectrophotometer at an acceptance angle of 0°. As a result, the degree of image sticking was about 2% or less, and the image was displayed satisfactorily.

### Embodiment 2

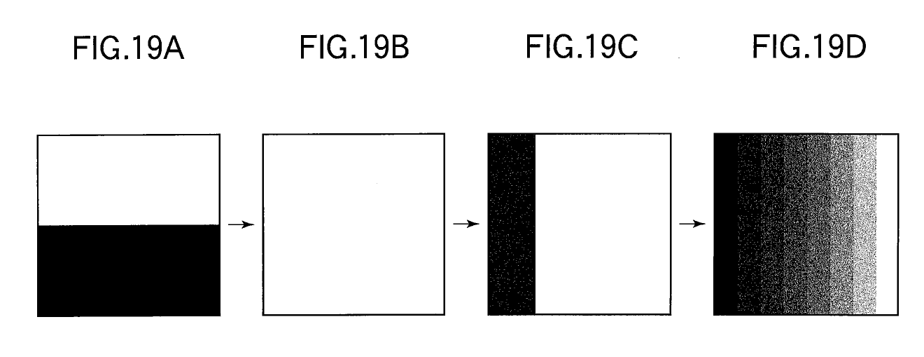

FIGS. 19A to 19D show a display screen of a liquid crystal display element 1.

First, as shown in FIG. 19A, an image or pattern was displayed for one week in a memorized display mode with the top half and the bottom half of the element in the planar state (state to reflect green) and the focal conic state (black state), respectively. Thereafter, a reset voltage of 36 V was applied to reset the liquid crystal to the planar state at all pixels, whereby green was displayed throughout the display screen (FIG. 19B). Thereafter, a voltage Vp=20 V was applied for a voltage application period of 8.5 ms to display preliminary gray levels on a binary basis, i.e., a gray level “0” and a gray level “N−1” among N gray levels (FIG. 19C). Next, a voltage Vp=10 V was applied with the voltage application period varied within the range from about 40 ms to about 160 ms to perform an additional write in an superimposing mode. Thus, a gradation pattern including parts at intermediate gray levels was displayed (FIG. 19D). The present embodiment employs the same driving method as that described with reference to FIGS. 14A to 14C.

The degree of image sticking on the element was measured in the state shown in FIG. 19D in the same manner as in Embodiment 1. As a result, the degree of image sticking was about 2% or less, and the image was satisfactorily displayed. In this embodiment, preliminary display can be performed at a speed higher than that of Embodiment 1.

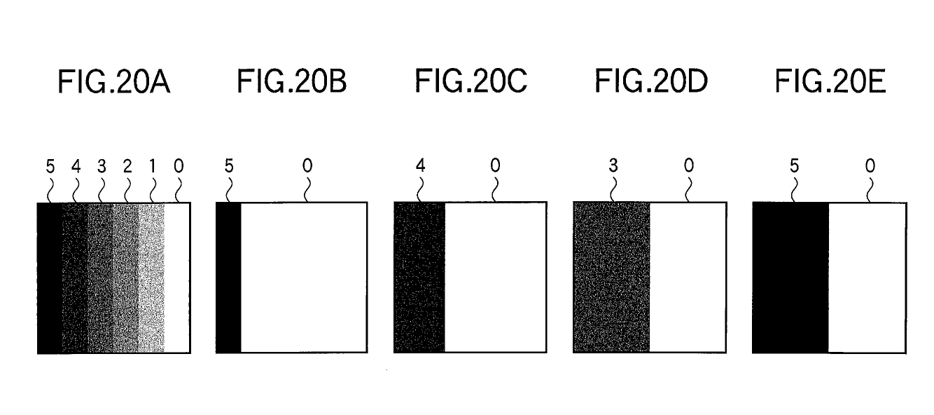

When preliminary gray levels are displayed on a binary basis as in the present embodiment, character information and brief image information can be displayed at a high speed. The image can be displayed at high definition by the additional write or rewrite performed subsequently. Binary display images suitable for such an additional write or rewrite are shown in FIGS. 20B, 20C, and 20D. FIG. 20A shows an image or pattern displayed at six gray levels, i.e., gray levels “0” to “5” by way of example. FIG. 20B shows a binary state of display having gray levels “0” and “5”. FIG. 20C shows a binary state of display having gray levels “0” and “4”. FIG. 20D shows a binary state of display having gray levels “0” and “3”. Let us assume that image data itself is converted into binary values using a certain density as a threshold as shown in FIG. 20E. Then, when an additional write or rewrite is performed on the resultant preliminary image, an elaborated driving method must be used. Specifically, the method must have both of a mode of driving to increase a density (darken) and a mode of driving for decreasing a density (increasing brightness). It is therefore preferable to perform preliminary display in the manners shown in FIGS. 20B, 20C, and 20D in which an additional write or rewrite can be performed only by driving the liquid crystal to increase density (darken).

### Embodiment 3

The present embodiment is similar to Embodiment 1 except that an additional write using a voltage of 10 V and a voltage application period of 20 ms is repeated eight times. This embodiment takes advantage of the fact that an intermediate gray level is displayed at lower reflectance, the greater the number of writes performed. As a result, the degree of image sticking was about 2% or less, and an image was satisfactorily displayed. In this embodiment, an image undergoes less significant changes at the time of an additional write when compared to Embodiment 1.

### Comparative Example 1

A reset voltage of 36 V was applied similarly to Embodiment 1, and an image was thereafter displayed by applying a voltage of 20 V with the voltage application period varied within the range from about 1 ms to about 20 ms, the image being preceded by no preliminary image. As a result, the maximum degree of image sticking was measured at about 5%, and a previous image which had been displayed in the memorized display mode was observed as a faint afterimage.

### Embodiment 4

An image was displayed in the same manner as in Embodiment 1 except that a previous image was displayed in the memorized display mode for one month as shown in FIG. 18A. The degree of image sticking was about 3% or less, and the image was satisfactorily displayed.

### Comparative Example 2

An image was displayed in the same manner as in Embodiment 1 except that a previous image was displayed in the memorized display mode for one month as shown in FIG. 18A. As a result, the maximum degree of image sticking increased to about 12%, and the previous image which had been displayed in the memorized display mode was observed as an afterimage.

### (Specific Configuration and Manufacturing Method of Liquid Crystal Display Element 1)

A specific configuration of the liquid crystal display element 1 used in the above-described mode of the invention and a method of manufacturing the element will now be described. In the above-described mode of the invention, two polycarbonate (PC) film substrates cut in a rectangular shape having longitudinal and transversal dimensions of, for example, 10 cm×8 cm are used as the top substrate 7 and the bottom substrate 9 which are transparent. Glass substrates or film substrates made of polyethylene terephthalate (PET) or the like may be used instead of PC substrates. Such film substrates have sufficient flexibility. Although both of the top substrate 7 and the bottom substrate 9 have translucency, the bottom substrate 9 may obviously be made opaque instead of providing the visible light absorbing layer 15.

For example, an indium tin oxide is a typical material used to form the scan electrodes 17 and the data electrodes 19. Alternatively, transparent conductive films made of an indium zinc oxide (IZO) or the like or photo-conductive films made of amorphous silicon or the like may be used.

In the present embodiment, transparent electrodes are patterned to form 320 scan electrodes 17 and 240 data electrodes 19 in the form of stripes at a pitch of 0.24 mm to enable QVGA display of, for example, 320×240 dots.

Various types of known nematic liquid crystals may be used. Cholesteric liquid crystal compositions having dielectric constant anisotropy Δ∈ satisfying 20≦Δ∈≦50 are preferably used. Dielectric constant anisotropy Δ∈ of 20 or higher allows a chiral material to be selected from a wide range of usable materials. Dielectric constant anisotropy Δ∈ lower than the above-described range results in an increase in the voltage for driving the liquid crystal layer. Dielectric constant anisotropy Δ∈ higher than the above-described range degrades the stability and reliability of the liquid crystal display element, and the element becomes more vulnerable to image defects and image noises.

Refractive index anisotropy Δn of a cholesteric liquid crystal is an important physical property which dominates image quality. The cholesteric liquid crystal of the element preferably has refractive index anisotropy Δn satisfying 0.18≦Δn≦0.24. When the refractive index anisotropy Δn is lower than the range, the liquid crystal 3 has a low reflectance in the planar state, and a dark image having insufficient brightness will be displayed. When the refractive index anisotropy Δn is higher than the range, the liquid crystal 3 has significant scatter reflections in the focal conic state, and the display screen has insufficient color purity and contrast which can result in a blurred image. Further, when the refractive index anisotropy Δn is higher than the range, the cholesteric liquid crystal has high viscosity which reduces the speed of response.

The cholesteric liquid crystal preferably has a specific resistance ρ satisfying 10¹⁰≦ρ≦10¹³ Ω·cm. A voltage increase and degradation of contrast at a low temperature can be more effectively suppressed, the lower the viscosity of the cholesteric liquid crystal.

Preferably, each of the electrodes 17 and 19 may be coated with a functional film, e.g., an insulation film or an alignment film for controlling the alignment of liquid crystal molecules (neither of such films is shown). The insulation film has the function of preventing shorting between electrodes adjacent to each other, and the film also serves as a gas barrier layer having the function of improving the reliability of the liquid crystal display element 1. A polyimide resin or an acryl resin may be used as the alignment film. In the above-described mode of the invention, for example, alignment films are applied throughout the substrates to coat the electrodes. The alignment films may be also used as insulating thin films.

The thickness (cell gap) d of the liquid crystal layer 3 must be kept uniform. In order to maintain a predetermined cell gap d, spherical spacers made of a resin or inorganic oxide are dispersed in the liquid crystal 3. Alternatively, a plurality of columnar spacers coated with a thermoplastic resin on the surface thereof may be formed in the liquid crystal 3. In the liquid crystal display element 1 of the above-described mode of the invention, spacers (not shown) are inserted in the liquid crystal layer to keep the cell gap d uniform. It is more preferable to form wall structures having adhesive properties around the pixels. Preferably, the cell gap d is within a range satisfying 3 μm≦d≦6 μm. When the cell gap d is smaller than the range, the G liquid crystal 3 has a low reflectance in the planar state. When the cell gap d is greater than the range, an excessively high driving voltage will be required. In the above-described mode of the invention, the cell gap d is set at 4 μm.

For example, general-purpose STN driver ICs having a TCP (tape carrier package) structure are used as the driver ICs for the scan electrodes and the data electrodes.

A method of manufacturing the liquid crystal display element 1 in the above-described mode of the invention will now be described.

ITO transparent electrodes are formed using a sputtering process on two PC film substrates 7 an 9 which have been cut to have longitudinal and transversal dimensions of, for example, cm and 8 cm. The ITO electrodes are then patterned at a photolithographic step to form electrodes in the form of stripes having a pitch of 0.24 mm (scan electrodes 17 and data electrodes 19) on the respective substrates. Thus, stripe-like electrodes are formed on the two PC film substrates, respectively, to allow QVGA display of, for example, 320×240 dots.

Then, a polyimide type alignment film material is applied to the stripe-like transparent electrodes on each of the two PC film substrates to a thickness of about 70 nm using a spin coat process. The two PC film substrates coated with the alignment material are then baked for one hour in an oven at 90° C. to form alignment films.

Then, an epoxy type seal material 21 is applied to a peripheral part of either of the PC film substrates using a dispenser. Next, spherical spacers (manufactured by SEKISUI FINE CHEMICAL) are dispersed on the other PC film substrate i.e., the substrate 9 or 7 to adjust the cell gap (the thickness of the liquid crystal layer) to about 4 μm. Then, the two PC film substrates 7 and 9 are combined and heated for one hour at 160° C. to cure the seal material 21. Then, a cholesteric liquid crystal LCg for green is injected using a vacuum injection process, and the injection port is thereafter sealed with an epoxy type sealing material to fabricate a liquid crystal display panel 6.

Next, a visible light absorbing layer 15 is disposed on a bottom surface of the bottom substrate 9. General purpose STN driver ICs in a TCP structure are then crimped to terminal parts of the scan electrodes 17 and data electrodes 19 of the liquid crystal display panel, and a power supply circuit and a control section 23 are further connected. Thus, a liquid crystal display element 1 capable of QVGA display is completed.

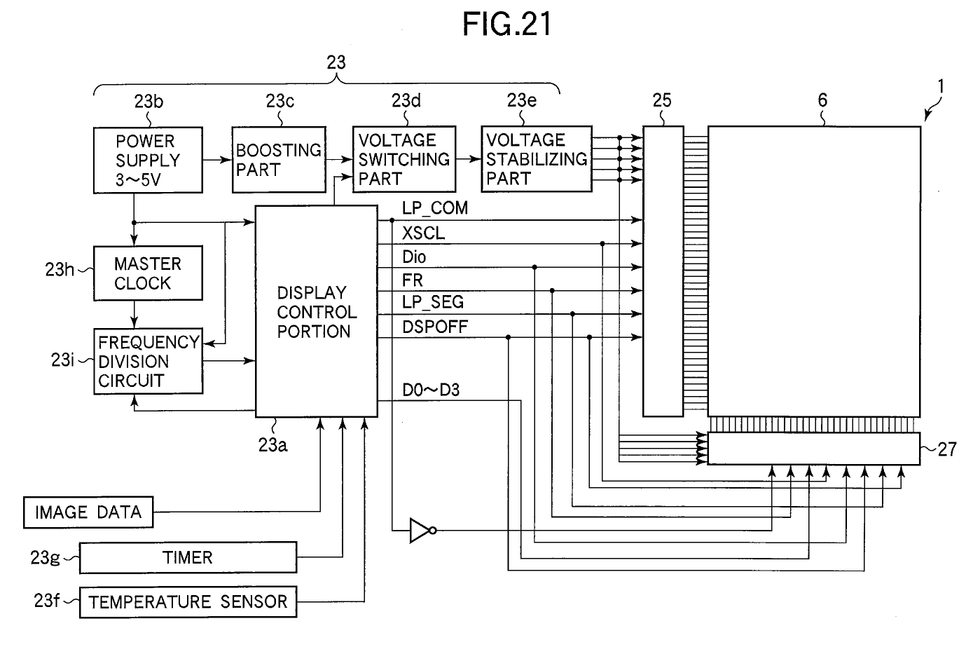

FIG. 21 is an illustration of a configuration of the liquid crystal display element 1 showing the control section 23 in more detail.

As shown in FIG. 21, the control section 23 includes a power supply portion which converts a DC voltage ranging, for example, from 3 to 5 V into DC voltages required to drive the liquid crystal display panel 6. The control section 23 also includes a display control circuit (display control portion) 23a which exercises control for starting a process of resetting the display area, generates predetermined control signals for displaying an image on the display section, and switches scan speeds and driving voltages. Further, the control section 23 includes a plurality of frame buffers (gray level data memories) for storing input image data input from an external system and storing M sub gray levels determined as described above and a detecting portion for detecting the timing at which the process of resetting the display section is started.

The power supply portion includes a power supply 23b for supplying the DC voltage ranging from 3 to 5 V, a boosting part 23c, a voltage switching part 23d, and a voltage stabilizing part (regulator) 23e. For example, the boosting part 23c includes a DC-DC converter for boosting the input voltage ranging from 3 to 5 V to a voltage required for driving the display section, e.g., a voltage in the range from about 30 to about 40 V. The voltage switching part 23d generates a plurality of required voltage levels which depend on a gray level value of each pixel and depend on whether each pixel is selected or not using the voltage boosted by the boosting part 23c and the input voltage. The voltage stabilizing part 23e includes a Zener diode, an operational amplifier, and the like. It stabilizes the voltages generated by the voltage switching part and supplies them to the scan electrode driving circuit and the data electrode driving circuit 27 provided in the liquid crystal display panel 6.

The control section may include detecting portions such as a temperature sensor 23f and a timer 23g. For example, the temperature sensor 23f may be used to detect the temperature of the external environment where the liquid crystal display element 1 is situated, and driving conditions for the display element may be changed by the control circuit 23a accordingly. An elapsed time may be measured by the timer 23g to allow the driving conditions for the display element to be changed according to the elapsed time.

The display control circuit 23a generates driving data based on gray level data D0 to D3 read out from frame buffers and data of preset driving waveforms. At this time, a reference clock signal generated by a master clock 23h is subjected to frequency division at a frequency division circuit 23i to generate a driving waveform associated with a gray level value. The display control circuit 23a outputs driving data thus generated to the scan electrode driving circuit 25 and the data electrode driving circuit 27 according to a data fetch clock XSCL. Further, the display control circuit 23a outputs control signals such as a scan direction signal (shift pulse) LP_COM, a pulse polarity control signal FR, a frame start signal Dio, a data latch/scan shift signal LP_SEG, and a driver output off signal DSPOFF to the circuits 25 and 27.

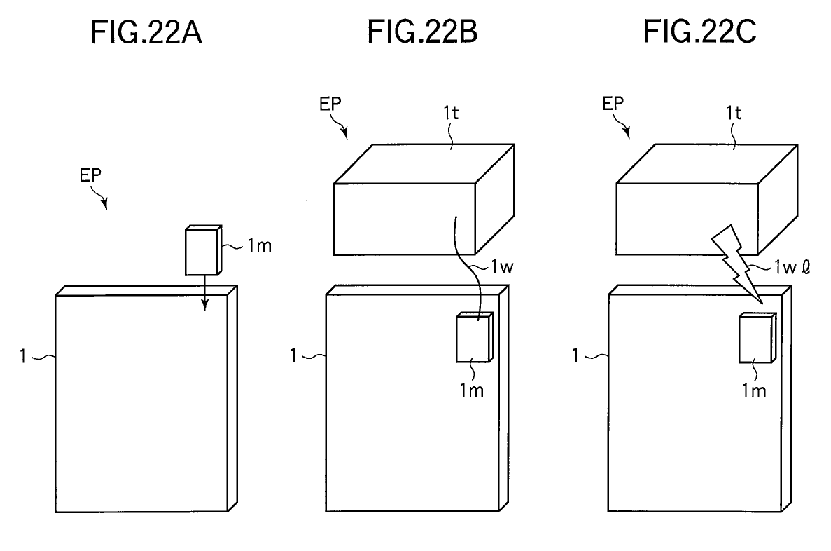

Electronic paper is completed by providing the liquid crystal display element 1 thus completed with an input/output device and a control device for exercising overall control of the element (neither of the devices is shown). FIGS. 22A to 22C show specific examples of electronic paper EP having a liquid crystal display element 1 in the above-described mode of the invention. FIG. 22A shows electronic paper EP which is configured to be used with a non-volatile memory 1m having image data stored therein in advance by inserting and removing the memory to and from a liquid crystal display element 1 in the above-described mode of the invention. For example, image data in a personal computer or the like may be stored in the non-volatile memory 1m, and an image may be displayed by inserting the memory into the electronic paper EP.

FIG. 22B shows electronic paper EP configured by incorporating a non-volatile memory 1m in a liquid crystal display element 1 in the above-described mode of the invention. For example, image data stored in a terminal it (the terminal it may form a part of the electronic paper EP) can be transferred by wire and stored in the non-volatile memory 1m to display an image.

FIG. 22C shows an example in which a wireless transmission/reception system iwl (e.g., a wireless LAN or Bluetooth system) is provided for a terminal it and a liquid crystal display element 1. Image data stored in the terminal it may be transferred through the wireless transmission/reception system 1wl and stored in a non-volatile memory 1m to display an image.

As described above in detail, in the above-described mode of the invention, a driving method allowing suppression of an afterimage attributable to image sticking can be provided along with a display element, an electronic terminal apparatus, and a display system employing the method.

The invention is not limited to the above-described mode for carrying out the same and may be modified in various ways.

Although a mode for carrying out the invention has been described above by describing a liquid crystal display element 1 selectively reflecting green light by way of example, the invention is not limited to such an element. The invention may be similarly applied to liquid crystal display elements having cholesteric liquid crystals for selectively reflecting red and blue rays of light enclosed therein. Further, a color liquid crystal display element may be provided by stacking a red liquid crystal display element for selectively reflecting red light, a green liquid crystal display element for selectively reflecting green light, and a blue liquid crystal display element for selectively reflecting blue light one over another and by disposing a light absorbing layer on the bottom of the stack. The driving method according to the invention may be used in each of the liquid crystal display elements to achieve the effect of suppressing an afterimage attributable to image sticking and to perform color display in a satisfactory manner.

Although the display section in the above-described mode of the invention is driven on the basis of passive driving utilizing electrodes provided in the form of a matrix, the invention is not limited to such a driving method. The invention may alternatively be used with active driving carried out using a TFT (thin film transistor) as a switching element at each pixel and optical writing systems utilizing a photoconductive layer.

What is claimed is:

1. A method of driving a liquid crystal display element, comprising the steps of:
(a) driving a liquid crystal for a relatively short voltage application period to display preliminary gray levels; and
(b) driving the liquid crystal for a voltage application period longer than the relatively short voltage application period to display desired gray levels.

2. The method according to claim 1, comprising a reset step for resetting the liquid crystal to an initial state prior to the preceding step (a).

3. The method according to claim 2, wherein the voltage applied to the liquid crystal at the step (a) is higher than the voltage applied to the liquid crystal at the step (b).

4. The method according to claim 3, wherein the preliminary gray levels displayed at the step (a) comprise only relatively high and/or low gray levels.

5. The method according to claim 4, wherein the preliminary gray levels are binary values.

6. A method of driving a liquid crystal display element displaying an image with N gray levels (N represents 3 or a greater natural number), the method comprising the steps of:
dividing a gray level “i” into M sub gray levels to display the gray level i (0≦is N−1) by performing a superimposing rewrite process M times (M≧2); and
performing the M rewrite processes with conditions for voltage application to the liquid crystal varied between the first to M-th processes such that the M sub gray levels are sequentially superimposed to display the gray level “i”.

7. The method according to claim 6, wherein the sum of the M sub gray levels is given by (i1+i2+ . . . +i(m−1)+im)=i when the M sub gray levels of the gray level “i” are represented by “i1”, “i2”, . . . “i(m−1)”, and “im”.

8. The method according to claim 6, wherein sa<s(a+1) and/or t(a+1)<ta holds true, where:
sa represents a maximum gray level within a gray level range expressed by 0≦i<(N−1)/2 and ta represents a minimum gray level within a gray level range expressed by (N−1)/2≦i≦(N−1), the gray level ranges being defined for a gray level obtained as a result of the first to a-th (1≦a≦M) superimposing rewrite processes; and
s(a+1) represents a maximum gray level within a gray level range expressed by 0≦i<(N−1)/2 and t(a+1) represents a minimum gray level within a gray level range expressed by (N−1)/2≦i≦(N−1), the gray level ranges being defined for a gray level obtained as a result of the (a+1)-th rewrite process performed after the a-th process.

9. The method according to claim 8, wherein the voltage applying conditions include voltages applied to the liquid crystal at the first to M-th rewrite processes having magnitudes descending in the order of the processes and periods for voltage application to the liquid crystal at the first to M-th rewrite processes having durations ascending in the order of the processes.

10. The method according to claim 8, wherein when the (a+1)-th rewrite process is performed to superimpose a sub gray level i(a+1) on a pixel having a gray level (i1+i2+ . . . +i(a−1)+ia) obtained at the a-th process, the voltage application period of the voltage applying conditions used at the (a+1)-th rewrite process is a difference between a voltage application period t to obtain the gray level (i1+i2+ . . . +i(a−1)+ia+i(a+1)) and a voltage application period t to obtain the gray level (i1+i2+ . . . +i(a−1)+ia).

11. The method according to claim 6, wherein the liquid crystal is reset to an initial state prior to the first rewrite process.

12. The method according to claim 1, wherein the liquid crystal is a cholesteric liquid crystal.

13. The method according to claim 12, wherein the initial state of the liquid crystal is a planar state in which light having a particular wavelength is selectively reflected.

14. A liquid crystal display element comprising:
a liquid crystal display panel having a first substrate formed with a plurality of scan electrodes extending in a first direction, a second substrate formed with a plurality of data electrodes extending in a second direction different from the first direction, and a liquid crystal layer formed between the first and second substrates;
a scan electrode driving circuit applying a scan pulse voltage that is a combination of different voltage levels to the plurality of scan electrodes, the voltage levels depending on whether the electrodes are selected or not;
a data electrode driving circuit applying a data pulse voltage that is a combination of different voltage levels to the plurality of data electrodes in association with the scan pulse voltage, the voltage levels depending on data to be written; and
a control section supplying pulse control signals for controlling the voltage levels of the scan pulse voltage and the data pulse voltage to the scan electrode driving circuit and the data electrode driving circuit, wherein
the control section displays gray levels by performing the steps of
(a) driving the liquid crystal for a relatively short voltage application period to display preliminary gray levels; and
(b) driving the liquid crystal for a voltage application period longer than the relatively short voltage application period to display desired gray levels.

15. The liquid crystal display element according to claim 14, wherein the control section resets the liquid crystal to an initial state prior to the step (a).

16. The liquid crystal display element according to claim 15, wherein the voltage applied to the liquid crystal at the step (a) is higher than the voltage applied to the liquid crystal at the step (b).

17. The liquid crystal display element according to claim 16, wherein a selection period for the scan electrodes at the step (a) is shorter than a selection period for the scan electrodes at the step (b).

18. The liquid crystal display element according to claim 14, wherein the liquid crystal is a cholesteric liquid crystal.

19. The liquid crystal display element according to claim 18, wherein the initial state of the liquid crystal is a planar state in which light having a particular wavelength is selectively reflected.

20. The liquid crystal display element according to claim 19, wherein:
a plurality of the liquid crystal display panels are stacked; and
the initial states of the liquid crystals in the liquid crystal display panels are planar states in which respective light rays having different wavelengths are selectively reflected.

21. Electronic paper displaying an image, comprising the liquid crystal display element according to claim 14.
